(19) United States
(12) Patent Application Publication
(10) Pub. No.: US 2026/0038369 A1
(43) Pub. Date: Feb. 5, 2026

(54) Systems and Methods for Determining Appropriate Curve Warning Signage

(71) Applicant: Georgia Tech Research Corporation, Atlanta, GA (US)

(72) Inventors: Yichang James Tsai, Atlanta, GA (US); Chengbo Ai, Atlanta, GA (US); Marius Michel Francois-Marchal, Atlanta, GA (US); Cibi Pranav, Atlanta, GA (US); Nicolas Six, Atlanta, GA (US); Don Kushan Saminda Wijeratne, Atlanta, GA (US); Yiching Wu, Atlanta, GA (US); Zhongyu Yang, Atlanta, GA (US); Pingzhou Yu, Atlanta, GA (US)

(21) Appl. No.: 18/997,410

(22) PCT Filed: Jul. 31, 2023
(86) PCT No.: PCT/US2023/071341

§ 371 Date: Jan. 21, 2025

Related U.S. Application Data
(60) Provisional application No. 63/369,811, filed on Jul. 29, 2022.

(51) Int. Cl. G08G 1/09; G08G 1/01

(52) U.S. Cl. CPC G08G 1/09; G08G 1/0112; G08G 1/0141; G08G 1/0145

(57) ABSTRACT

An exemplary embodiment of the present disclosure provides a method of improving curve signage, comprising: receiving data from a plurality of user devices, the data collected by the plurality of user device when the plurality of user devices are each located within a distinct automobile when the respective automobile is traversing along one or more roads, the one or more roads comprising one or more curved portions; determining, based, at least in part, on the data, desired curve signage to be displayed on the one or more curved portions; and displaying a list of the desired curve signage to be displayed on the one or more curved portions.

### CROSS-REFERENCE TO RELATED APPLICATIONS

This application claims the benefit of U.S. Provisional Application Ser. No. 63/369,811 filed on 29 Jul. 2022, which is incorporated herein by reference in its entirety as if fully set forth below.

### GOVERNMENT LICENSE RIGHTS

This invention was made with government support under Agreement No. PI #0016839, awarded by the National Cooperative Highway Research Program. The government has certain rights in the invention.

### FIELD OF THE DISCLOSURE

The various embodiments of the present disclosure relate generally to systems and methods for determining appropriate signage along curves of roadways.

### BACKGROUND

A disproportionally high number of serious vehicle crashes (25% of fatal crashes) occur on horizontal curves, even though curves represent only a fraction of the roadway network (5% of highway miles). When the friction is insufficient to compensate for the lateral force experienced by a vehicle being driven on a curve, the vehicle will slide and run off the road (ROR). This is a high priority problem that has the great interest among transportation agencies throughout the nation because the ultimate goal is to reduce serious vehicle crashes on curves. The problem is complicated because, based on our communication with state DOTs' engineers, the in-service curve characteristics, including superelevation, may change over time because of new pavement resurfacings. Therefore, understanding in-service curve characteristics can be vital to improving the safety of curves. The in-service curve characteristics, including curve radius, superelevation, and ball bank indicator (BBI) angles, can be vitally important for setting up adequate curve advisory speeds and for performing curve safety assessment and analysis. A BBI measurement is one of the important curve safety indicators specified by the Manual on Uniform Traffic Control Devices (MUTCD) (2009); it is a combined indicator that includes curvature, superelevation, side friction condition, and driving speed.

However, acquiring this detailed level roadway characteristics information on in-service curves at the network level can be very difficult for transportation agencies. For example, state DOTs, like the Georgia Department of Transportation (GDOT) use an electronic device (manufactured by Rieker Inc.) to collect BBI measurements in the field. For the curves to be assessed, GDOT engineers make more than two runs on each curve at incremental speeds and measure the BBI in each run to determine a curve's adequate advisory speed. This operation typically requires two workers (one drives a vehicle while another records BBI) and is labor-intensive, time-consuming, and costly. Once a representative BBI value, along with an adequate advisory speed for each curve, has been determined, countermeasures (such as setting up an advisory speed at the beginning of the curve or applying a High Friction Surface Treatment (HFST) or some other treatment) can be applied based on an analysis of the potential safety improvement, completion of benefit-cost ratio analysis, and determination of funding availability.

In summary, current transportation agencies' practices use dedicated devices operated by designated engineers to collect curve characteristics information at the network-level for curve safety condition assessment. The practices are typically labor-intensive, time-consuming, and costly. Because the current practices and methods are time-consuming, labor-intensive, and costly, it typically takes one to two years to complete the curve safety assessment of 100% of their state-maintained roadways. For local transportation agencies (counties and cities) that have limited resources, the process of completing a network curve safety assessment can take longer. Thus, roadway curve sections that need safety improvement(s) are often not identified until accidents occur. Because of long intervals between curve safety assessments, it is difficult for DOTs to take proactive actions in terms of identifying problems or making timely curve safety improvements. The constraints of current practices and methods significantly hinder transportation agencies' capabilities to reduce the disproportionally high number of fatalities on curves. The problem of current practices significantly hinders transportation agencies' abilities to proactively apply safety improvements and reduce the number of crashes on roadway curves. Thus, there is an urgent need to develop enhanced methods that enable transportation agencies to perform network-level curve safety assessments in a timely, cost-effective, and safe manner. Because transportation agencies' funds/budgets are often limited and must be used wisely, an innovative and cost-effective method that enables transportation agencies to do more with less is desired.

### BRIEF SUMMARY

An exemplary embodiment of the present disclosure provides a method of improving curve signage, comprising: receiving data from a plurality of user devices, the data collected by the plurality of user device when the plurality of user devices are each located within a distinct automobile when the respective automobile is traversing along one or more roads, the one or more roads comprising one or more curved portions; determining, based, at least in part, on the data, desired curve signage to be displayed on the one or more curved portions; and displaying a list of the desired curve signage to be displayed on the one or more curved portions.

In any of the embodiments disclosed herein, the data can be indicative of speeds of the user devices.

In any of the embodiments disclosed herein, the data can be indicative of GPS locations of the user devices.

In any of the embodiments disclosed herein, the data can comprise IMU data of the user devices.

In any of the embodiments disclosed herein, the IMU data can comprise accelerometer data of the user devices.

In any of the embodiments disclosed herein, the IMU data can comprise gyroscope data of the user devices.

In any of the embodiments disclosed herein, the IMU data can comprise magnetometer data of the user devices.

In any of the embodiments disclosed herein, the data can comprise video data of the one or more roads.

In any of the embodiments disclosed herein, the method can further comprise determining, base at least in part on the data, locations of the one or more curved portions.

In any of the embodiments disclosed herein, determining locations of the one or more curved portions can comprise determining a point of curvature for the one or more curved portions.

In any of the embodiments disclosed herein, determining locations of the one or more curved portions can comprise determining a point of tangent for the one or more curved portions.

In any of the embodiments disclosed herein, determining the desired curve signage to be displayed on the one or more curved portions can comprise determining a curve radius for the one or more curved portions.

In any of the embodiments disclosed herein, the curve radius can be based, at least in part, on GPS data and/or roadway centerline data in the data obtained from the plurality of user devices.

In any of the embodiments disclosed herein, determining the desired curve signage to be displayed on the one or more curved portions can comprise determining a deviation angle for the one or more curved portions.

In any of the embodiments disclosed herein, the deviation angle can be based, at least in part, on GPS data and/or roadway centerline data in the data obtained from the plurality of user devices.

In any of the embodiments disclosed herein, determining the desired curve signage to be displayed on the one or more curved portions can comprise determining a superelevation for the one or more curved portions.

In any of the embodiments disclosed herein, the superelevation can be based, at least in part, on speed data in the data obtained from the plurality of user devices and a path radius and BBI determined based, at least in part, on the data obtained from the plurality of user devices.

In any of the embodiments disclosed herein, determining the desired curve signage to be displayed on the one or more curved portions can comprise determining an advisory speed for the one or more curved portions.

In any of the embodiments disclosed herein, the determination of the advisory speed for the one or more curved portions can be based, at least in part, on a curve radius and superelevation of the one or more curved portions.

In any of the embodiments disclosed herein, the curve radius and superelevation of the one or more curved portions can be determined based, at least in part, on the data obtained from the plurality of user devices.

In any of the embodiments disclosed herein, the advisory speed can be determined using the following equation:

$${V}_{adv} = \sqrt{15 * ( \frac{e}{100} + {f}_{max} ) * {R}_{c}}$$

wherein, fₘₐₓ is a maximum allowed side friction factor, R_{c} is a curve radius of the one or more curved portions expressed in feet, and V_{adv} is the advisory speed expressed in miles per hour.

In any of the embodiments disclosed herein, the method can further comprise determining, based, at least in part, on the data, one or more kinematic properties of the automobiles traversing along one or more roads.

In any of the embodiments disclosed herein, the one or more kinematic properties can comprise a path radius taken by the automobiles when traversing along the one or more curved portions.

In any of the embodiments disclosed herein, the path radius can be based, at least in part, on speed data and IMU data in the data obtained from a plurality of user devices.

In any of the embodiments disclosed herein, the one or more kinematic properties can comprise a ball bank indicator (BBI) of the automobiles when traversing along the one or more curved portions.

In any of the embodiments disclosed herein, the BBI can be based, at least in part, on IMU data in the data obtained from a plurality of user devices.

In any of the embodiments disclosed herein, the BBI can be determined, at least in part, based on the following equation:

$$α ( {t}_{i} ) = ( atan ( \frac{{( 1.47 * V ( {t}_{i} ) )}^{2}}{{gR}_{p} ( {t}_{i} )} ) - atan ( \frac{e ( {t}_{i} )}{100} ) ) * ( 1 + k )$$

wherein α(tᵢ) is the BBI at time tᵢ, V(tᵢ) is a speed of the respective automobile at time tᵢ, g is the gravitational force of Earth, Rₚ(tᵢ) is a path radius of the respective automobile at time tᵢ, and k is a roll rate of the respective automobile expressed in (rad/rad).

In any of the embodiments disclosed herein, displaying the list of the desired curve signage to be displayed on the one or more curved portions can comprise displaying a list of coordinates and a desired sign for each of the coordinates, each of the coordinates corresponding to a geographic location.

In any of the embodiments disclosed herein, displaying the list of the desired curve signage to be displayed on the one or more curved portions can comprise displaying a map, the map comprising the one or more curved portions and the desired curve signage to be displayed on the one or more curved portions.

In any of the embodiments disclosed herein, the plurality of user devices can be smartphones.

In any of the embodiments disclosed herein, the plurality of user devices can be tablets.

In any of the embodiments disclosed herein, the method can further comprise determining, based, at least in part, on the data, existing signage currently displayed on the one or more curved portions.

In any of the embodiments disclosed herein, the method can further comprise comparing the existing signage currently displayed on the one or more curved portions to the desired curve signage to be displayed on the one or more curved portions.

In any of the embodiments disclosed herein, the method can further comprise generating, based, at least in part, on the comparing, a list of signs to be displayed on the one or more curved portions, so that the existing signage currently displayed on the one or more curved portions matches the desired curve signage to be displayed on the one or more curved portions.

In any of the embodiments disclosed herein, the method can further comprise displaying the list of signs to be displayed on the one or more curved portions.

In any of the embodiments disclosed herein, displaying the list of signs to be displayed on the one or more curved portions can comprise displaying a list of coordinates and a desired sign for each of the coordinates, each of the coordinates corresponding to a geographic location.

In any of the embodiments disclosed herein, displaying the list of signs to be displayed on the one or more curved portions can comprise displaying a map, the map comprising the one or more curved portions and the signs to be displayed on the one or more curved portions.

Another embodiment of the present disclosure provides a method of calculating an advisory driving speed for a curved portion of a road, the method comprising: receiving data from a user device, the data collected by the user device when the user device is each located within an automobile while the automobile is traversing along a road comprising the curved portion; determining, based, at least in part, on the data, the advisory driving speed for the curved portion of the road; and generating an output indicative of the advisory driving speed of the curved portion of the road.

Another embodiment of the present disclosure provides a system for improving curve signage. The system can comprise one or more processors. The one or more processors, individually and/or collectively, can be configured to execute code cause the system to implement any of the methods or portions of methods disclosed herein.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic of a system for improving curve signage, in accordance with some embodiments of the present disclosure.

FIG. 2 provides flowchart illustrating data collection and computational methods, in accordance with some embodiments of the present disclosure.

FIG. 3 provides an illustrating of a coordinate system of an IMU of a mobile device, in accordance with some embodiments of the present disclosure.

FIG. 4 provides an illustration of temporal data registration of data tables with different sampling frequencies, in accordance with some embodiments of the present disclosure.

FIG. 5 provides an illustration of the difference between path radius and curve radius due to lateral movement within the lane.

FIG. 6 provides an illustration of the interaction between BBI and superelevation, lateral acceleration, and vehicle body roll.

FIG. 7 provides a plot of a roadway centerline with extracted curves.

FIG. 8 provides a plot of bearing angle with extracted curves.

FIG. 9 provides a plot showing the relationship between computed BBI and side-friction angle on NCAT test track with manually measured superelevation, in accordance with some embodiments of the present disclosure.

FIG. 10 provides a diagram showing locations on the NCAT test track where superelevation is manually measured.

FIGS. 11A-C provide plots of uncalibrated superelevation error at different speeds measured by a GoPro, first smartphone, and second smartphone, respectively, in accordance with some embodiments of the present disclosure.

FIG. 12 provides a plot of RMSE of uncalibrated superelevation, in accordance with some embodiments of the present disclosure.

FIG. 13 provides an illustration of a driving path with different driving behaviors, in accordance with some embodiments of the present disclosure.

FIGS. 14A-B provide plots of computed superelevation using path radius (FIG. 14A) vs. curve radius (FIG. 14B) in “good driving” cases, in accordance with some embodiments of the present disclosure.

FIG. 15 provides a plot of computed superelevation using curve radius as path radius in “bad driving” cases, in accordance with some embodiments of the present disclosure.

FIGS. 16A-B provide plots showing performance difference between different methods of path radius estimation, in accordance with some embodiments of the present disclosure.

FIGS. 17A-C provide plots showing the relationship between measured BBI angle and side-friction angle for a GoPro, first smartphone, and second smartphone, respectively, in accordance with some embodiments of the present disclosure.

FIGS. 18A-C provide plots showing calibrated superelevation error at different speeds for a GoPro, first smartphone, and second smartphone, respectively, in accordance with some embodiments of the present disclosure.

FIG. 19 provides a plot of RMSE of calibrated superelevation, in accordance with some embodiments of the present disclosure.

FIGS. 20A-D provide plots showing linear regression between BBI angles measured using different devices and expected BBI angles for a GoPro, first smartphone, second smartphone, and Rieker device, respectively, in accordance with some embodiments of the present disclosure.

FIG. 21 provides a map of State Route 17 in Georgia and selected curves used for testing some embodiments of the present disclosure.

FIG. 22 provides a computing device that can be used with some embodiments of the present disclosure

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

With the advancement of sensor technologies, low-cost mobile devices (such as smartphones, tablet PCs, GoPro cameras, etc.) that usually integrate various sensors (such as GPS sensors, accelerometers, magnetometer, and gyroscopes) are available to collect sensor data and vehicle's kinematic parameters, such as vehicle speed, lateral acceleration, rolling angle, etc. These sensor data and vehicle's kinematic parameters can be used to compute curve characteristics information, including radius, superelevation, and BBI values for network-level curve safety assessment.

Disclosed herein are enhanced curve safety assessment and computation methods that use low-cost mobile devices. The methods can use intra-agency, crowdsourced, low-cost mobile devices and multi-run data analysis to identify, in a timely manner, problematic roadway curves that need safety improvement. A goal of the methods disclosed herein is to reduce the current disproportionally high number of fatalities on roadway curves. The use of intra-agency, crowdsourced, low-cost mobile devices to collect sensor data on the roadway while engineers are performing other tasks can reduce engineers' time on the road and minimize their exposure to hazardous curve sections.

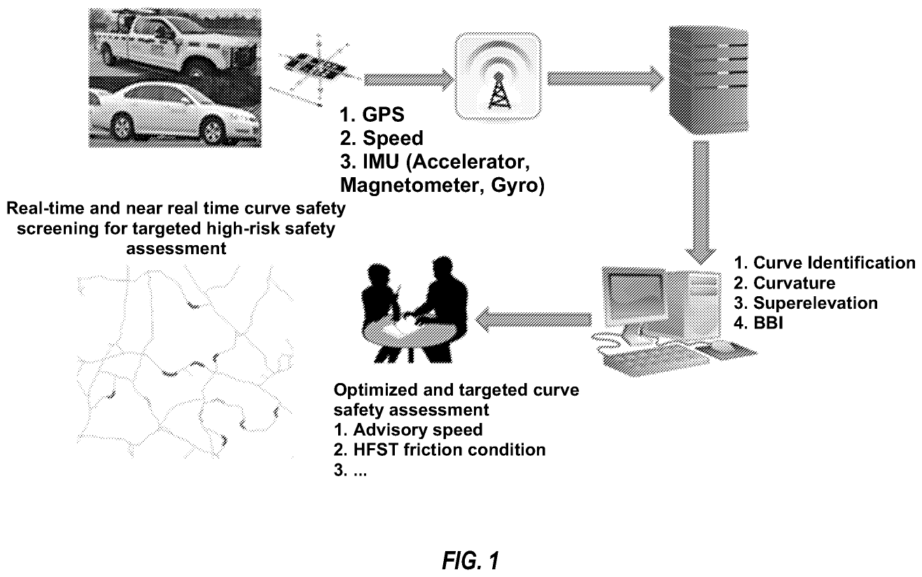

FIG. 1 illustrates a schematic diagram of an exemplary system for optimizing curve signage, in accordance with some embodiments of the present disclosure. The systems and methods disclosed herein provide intra-agency, crowdsourced data collection and computation framework by leveraging agencies' existing vehicles and transportation engineers. The framework can use low-cost mobile user devices (e.g., smartphones and/or tablet PCs) for collecting data (including GPS data, accelerations, gyroscope data, and image data) from multiple runs. Indeed, using the methodology, transportation engineers can collect data while performing other tasks.

As discussed above, it can be difficult for transportation agencies to take proactive action to make curve safety improvements in a timely manner because of the long interval between curve safety inspections (they are usually accomplished annually or bi-annually). The systems and methods disclosed herein, however, can provide low-cost means for transportation agencies to perform a preliminary network-level curve safety screening on a daily or weekly schedule. Once roadway sections in need of curve safety improvement are identified, a detailed curve safety assessment can be conducted on the identified targeted sections. This can enable transportation agencies to focus their time and attention on targeted roadway curve sections that need improvement, not those that do not need improvement. This can save significant time and cost for transportation agencies. This proactive and targeted attention, done on a daily, weekly, or monthly basis rather than an annual or biannual basis, will vastly improve the quality and timeliness of curve safety inspection and proactive improvements. The systems and methods disclosed herein are aimed at enhancing the current network-level curve safety assessment method, which is costly, labor-intensive, time-consuming, and often dangerous. The disclosed system and methods can provide a means for transportation agencies to proactively reduce fatalities in the most cost-effective and timeliest manner.

To optimize the data collection effort, an innovation of the inventive methods can creatively utilize intra-agency, crowdsourced, low-cost mobile devices. With the disclosed methods, roadway data can be collected using an agency's vehicles while its personnel are conducting other day-to-day operations. In this way, it is expected that the survey frequency can be increased from annually to, at least, weekly. Because an agency's vehicles traverse the same roads many times, multiple runs of data can be collected from different drivers at different times for a single curve section. The data can then be analyzed to eliminate biases that occur when data is collected only on a single run. Crowdsourcing data collected from the fleet and employees in a single transportation agency, i.e., intra-agency, can ensure data quality.

There are, currently, no crowdsourced, low-cost mobile applications that can productively and cost-effectively collect and analyze data (gathered from multiple runs by different drivers) for assessing roadway curve safety at the network level or that can perform BBI computation, super-elevation computation, and advisory speed determination. The proposed method, using a new intra-agency, crowdsourced data collection and computational framework, leverages a) existing, low-cost mobile user devices, (e.g., smartphones, tablet PCs, GoPro cameras, etc.) to collect multiple runs of sensor data, including GPS data and IMU data, and b) agencies' existing vehicles and transportation engineers (who can collect data while simultaneously performing other tasks). The data collection and computation framework of the methods disclosed herein comprise six modules, which are discussed in more detail below: 1) mobile data collection, 2) mobile data registration and processing, 3) driving kinematics calculation, 4) curve geometry calculation, 5) advisory speed calculation, and 6) curve warning sign design. The detailed data collection and computation framework is presented below.

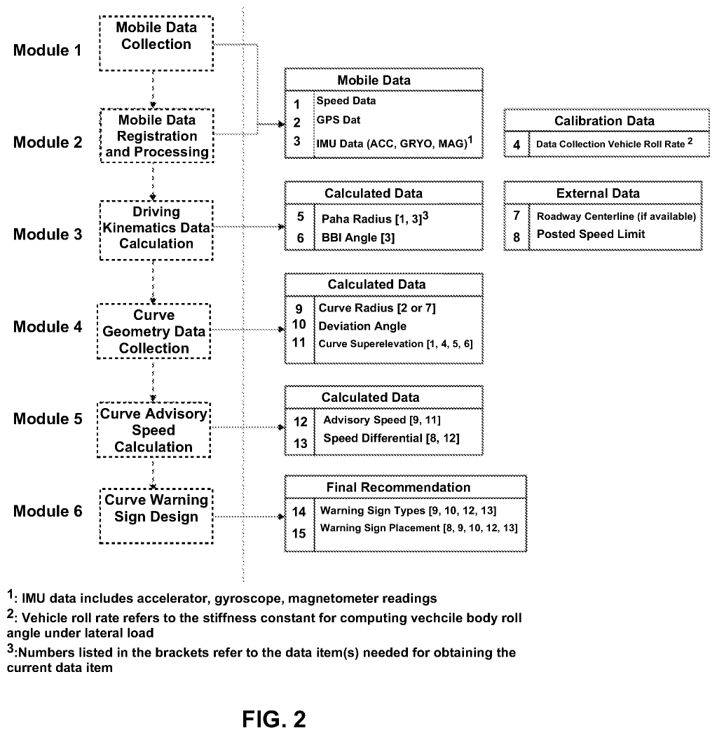

An exemplary cost-effective method that uses low-cost mobile user devices and leverages existing agency-owned vehicle fleets will now be discussed. The method can accurately and robustly collect and compute in-service super-elevation, BBI values, and advisory speed limits. The proposed method can also resolve the current technical challenges in terms of different driving speeds and driving behaviors that are expected when engineers collect data and simultaneously perform other daily tasks. The exemplary method is built upon a data collection and computation framework shown in FIG. 2.

An exemplary embodiment of the present disclosure provides a method of improving curve signage. The method can comprise receiving data from a plurality of user devices. The user devices can be many different user devices, including but not limited to smartphones, tablets, GoPros, and the like. The data can be collected by the user devices when the user devices are located within a distinct automobile and when the automobile is traversing along one or more roads. For example, data from a first device in a first automobile can be received, and data from a second device in a second automobile can be received. In some embodiments, each automobile can be equipped with multiple user devices. In particular, the user devices can collect certain information while the automobile traverses along curved portions of the road.

The data collected by the user devices can be transmitted to a remote computer for further processing. In some embodiments, the data can be transmitted in real time as the data is collected by the user devices. In some embodiments, the data can be stored locally on the user devices and transmitted to the remote device (e.g., a cloud-based server) at a later time. The remote device, e.g., server, can then analyze the data collected from the user devices.

The data collected by the user devices can be many different types of data. In some embodiments, the data can be GPS data associated with the user device over a period of time, In some embodiments the data can be indicative of the speed of the user device. In some embodiments, the data can be inertial measurement unit (“IMU”) data, including, but not limited to, accelerometer data, gyroscope data, and/or magnetometer data. In some embodiments, the data can comprise video data. For example, the user device can comprise a camera and the user device can collect video data as the automobile traverses the road. The video data can include video of the roadway and existing signage along the roadway.

The method can further comprise determining, based, at least in part, on the data, desired curve signage to be displayed on the one or more curved portions. The desired curve signage can be signage, for example, indicative of an advisory speed for the curved portions or any other signage instructing drivers about the curved portion of the road.

In any of the embodiments, the method can further comprise determining the locations of curves in the roadways. Determining the locations of the curves can comprise determining a point of curvature (location where curve begins when approaching from a particular direction) and/or a point of tangency (location where curve ends when approaching from a particular direction).

In some embodiments, determining the desired curve signage to be displayed on a curve of a road can comprise analyzing the data received from the user devices to calculate various parameters about the curve. Exemplary methods for using the data to determine these various characteristics are discussed below. For example, the curve radius for a particular curve can be determined. In some embodiments, the curve radius can be determined using GPS data and/or roadway centerline data (which can also be obtained from camera data or map data). In some embodiments, the deviation angle for a curve can be determined. The deviation angle can be determined using GPS data and/or roadway centerline data.

An important characteristic of the curve which can be determined by methods of the present disclosure is the superelevation of the curve. The superelevation of the curve can be determined using speed data from the user devices as well as path radius and BBI, both of which can be determined using data from the user devices.

As discussed above, determining the desired curve signage can comprise determining an advisory speed for the curve. The advisory speed can be determined using the curve radius and superelevation of the curve, both of which can be determined from the data from the user devices.

Determining the desired curve signage can further comprise determining one or more kinematic properties of the automobiles. In some embodiments, the kinematic property can be a path radius taken by the automobile when traversing the curve. In some embodiments, the path radius can be determined using the speed data and IMU data in the data obtained from a plurality of user devices. In some embodiments, the kinematic property can comprise a ball bank indicator (also referred to as a ball bank indicator angle) (“BBI”) when traversing the curve. The BBI can be determined utilizing the IMU data from the user devices.

Once the desired curve signage has been determined, the method can further comprise generating an output indicative of the desired curve signage. For example, in some embodiments, the output can be a display of the desired curve signage to be displayed on the curve. In some embodiments the display can be a list of the desired curve signage to be displayed on the curve. The list can comprise a list of coordinates corresponding to a geographic location and a desired sign for each of the coordinates. In some embodiments, the display can comprise a map showing the curve(s) and the desired curve signage to be displayed on the curve(s). In some embodiments, the output can be a command instructing that a particular sign should be displayed. In some embodiments, the command can also include a location for the particular sign to be displayed.

It can also be important to determine if the existing signage on a curve is consistent with the desired signage. Accordingly, in some embodiments, the method can further comprise determining existing signage currently displayed on the curve(s). In some embodiments, the existing signage can be determined by analyzing video data from the user devices that shows the existing signage. Determining the existing signage can comprise determining both the location and sign type for the existing signage.

In some embodiments, the method can further comprise comparing the existing signage currently displayed on the curve(s) to the desired curve signage to be displayed on the curve(s). In some embodiments, the method can further comprise generating, based on the comparing, a list of signs to be displayed on the curve(s), so that the existing signage currently displayed on the curve(s) matches the desired curve signage to be displayed on the curve(s). In some embodiments, the method can further comprise generating an output (e.g., a display) of a list of signs to be displayed on the curve(s). In some embodiments, the list can comprise a list of coordinates corresponding to a geographic location and a desired sign for each of the coordinates.

As discussed above, in addition to methods, some embodiments of the present disclosure provides systems for improving curve signage. The systems can comprise one or more processors. The processors can individually and/or collectively implement one or more steps of the methods disclosed herein. For example, in some embodiments, a first processor can comprise one or more steps of a method and a second processor can perform one or more other steps of the method. In some embodiments, the first and second processors can collectively perform one or more steps of the method. In some embodiments, the one or more processors can be part of a computing device.

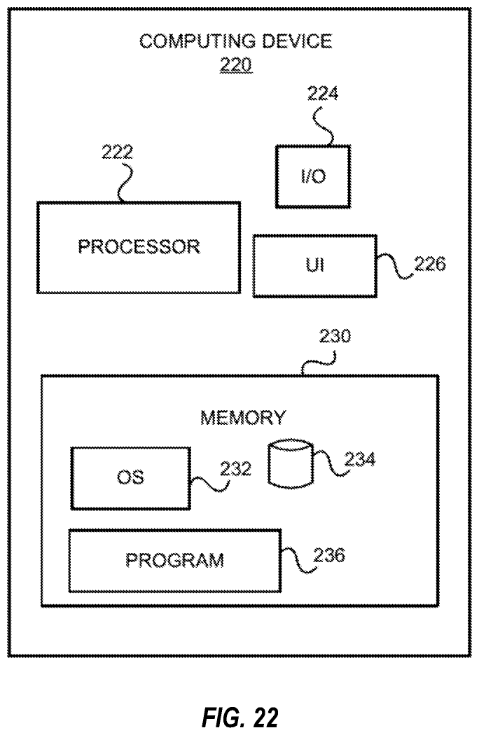

FIG. 22 illustrates an exemplary computing device that can be used to implement the methods (or one or more steps of the methods) disclosed herein. As will be appreciated by one of skill in the art, the computing device 220 can be configured to implement all or some of the features described in relation to the methods 1000 1100. As shown, the computing device 220 may include a processor 222, an input/output (“I/O”) device 224, a memory 230 containing an operating system (“OS”) 232 and a program 236. In certain example implementations, the computing device 220 may be a single server or may be configured as a distributed computer system including multiple servers or computers that interoperate to perform one or more of the processes and functionalities associated with the disclosed embodiments. In some embodiments, computing device 220 may be one or more servers from a serverless or scaling server system. In some embodiments, the computing device 220 may further include a peripheral interface, a transceiver, a mobile network interface in communication with the processor 222, a bus configured to facilitate communication between the various components of the computing device 220, and a power source configured to power one or more components of the computing device 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™ ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 222 to communicate with other devices via wired or wireless networks, whether local or wide area, private or public, as known in the art. A power source may be configured to provide an appropriate alternating current (AC) or direct current (DC) to power components.

The processor 222 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 222 may be one or more known processing devices, such as, but not limited to, a microprocessor from the Pentium™ family manufactured by Intel™ or the Turion™ family manufactured by AMD™. The processor 222 may constitute a single core or multiple core processor that executes parallel processes simultaneously. For example, the processor 222 may be a single core processor that is configured with virtual processing technologies. In certain embodiments, the processor 222 may use logical processors to simultaneously execute and control multiple processes. The processor 222 may implement virtual machine technologies, or other similar known technologies to provide the ability to execute, control, run, manipulate, store, etc. multiple software processes, applications, programs, etc. The processor 222 may also comprise multiple processors, each of which is configured to implement one or more features/steps of the disclosed technology. One of ordinary skill in the art would understand that other types of processor arrangements could be implemented that provide for the capabilities disclosed herein.

In accordance with certain example implementations of the disclosed technology, the computing device 220 may include one or more storage devices configured to store information used by the processor 222 (or other components) to perform certain functions related to the disclosed embodiments. In one example, the computing device 220 may include the memory 230 that includes instructions to enable the processor 222 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing device 220 may include a memory 230 that includes instructions that, when executed by the processor 222, perform one or more processes consistent with the functionalities disclosed herein. Methods, systems, and articles of manufacture consistent with disclosed embodiments are not limited to separate programs or computers configured to perform dedicated tasks. For example, the computing device 220 may include the memory 230 that may include one or more programs 236 to perform one or more functions of the disclosed embodiments.

The processor 222 may execute one or more programs located remotely from the computing device 220. For example, the computing device 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 222, perform one or more processes consistent with the disclosed embodiments. In some examples, the memory 230 may include a database 234 configured to store various data described herein. For example, the database 234 can be configured to store the software repository 102 or data generated by the repository intent model 104 such as synopses of the computer instructions stored in the software repository 102, inputs received from a user (e.g., responses to questions or edits made to synopses), or other data that can be used to train the repository intent model 104.

The computing device 220 may also be communicatively connected to one or more memory devices (e.g., databases) locally or through a network. The remote memory devices may be configured to store information and may be accessed and/or managed by the computing device 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 220 may also include one or more I/O devices 224 that may comprise one or more user interfaces 226 for receiving signals or input from devices and providing signals or output to one or more devices that allow data to be received and/or transmitted by the computing device 220. For example, the computing device 220 may include interface components, which may provide interfaces to one or more input devices, such as one or more keyboards, mouse devices, touch screens, track pads, trackballs, scroll wheels, digital cameras, microphones, sensors, and the like, that enable the computing device 220 to receive data from a user.

In example embodiments of the disclosed technology, the computing device 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the computing device 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 220 may include a greater or lesser number of components than those illustrated.

Below various portions of the methods discussed above are described in more detail. The discussion below, however, provides exemplary embodiments of the present disclosure and should not be construed as limiting the scope of the disclosure. The framework below is discussed in the context of certain “modules.” As used herein, the term “module” is meant to be broadly interpreted and can refer to one or more pieces of software, one or more processors, collections of method steps, etc. There are six modules shown in FIG. 2: a mobile data collection module, a mobile data registration and processing module, a driving kinematics calculation module, a curve geometry calculation module, an advisory speed calculation module, and a curve warning sign design module.

In Module 1, mobile devices, e.g., smartphones, tablets, Go-Pros, etc., can be used to collect vehicle speed, global positioning system (GPS), and inertial measurement unit (IMU) data. The collected data can be registered and processed in Module 2. In Module 3, data items related to the driver inputs and the interactions between vehicle and roadway (driving kinematics data) can be computed. This data can include the path radius of the driving trajectory and the BBI angle during the data collection. After driving kinematics data are processed, curve geometry data cam be computed in Module 4. While the data collected by the mobile device itself (without knowing vehicle's roll rate) is enough to estimate roadway superelevation, in some embodiments, better results can be obtained if the vehicle's roll rate, a property related to the vehicle's suspension, is available to calibrate the superelevation results. In addition, to obtain the curve radius and the curve deviation angle, the curve centerline can be used as external data input for computing these data items. With curve geometry data obtained, the advisory speed and the speed differential can be computed (with posted speed limit as external data input) as shown in Module 5. Finally, in Module 6, the computed data outcome from previous modules can be used to provide a curve warning sign design that provides proper warning sign selection and placement. Disclosed below are exemplary methods for using the data collected by the mobile devices to compute the data items in Modules 1-5 to support MUTCD curve warning sign design. Also discussed below is a new calibration method to estimate vehicle roll rate to compensate superelevation computation by considering the impact of vehicle body roll.

### Module 1: Mobile Data Collection

A mobile application referred to herein as “AllGather” was developed for mobile data collection and storage of the GPS trajectory, vehicle speed, IMU data, and onboard camera view during the data collection.

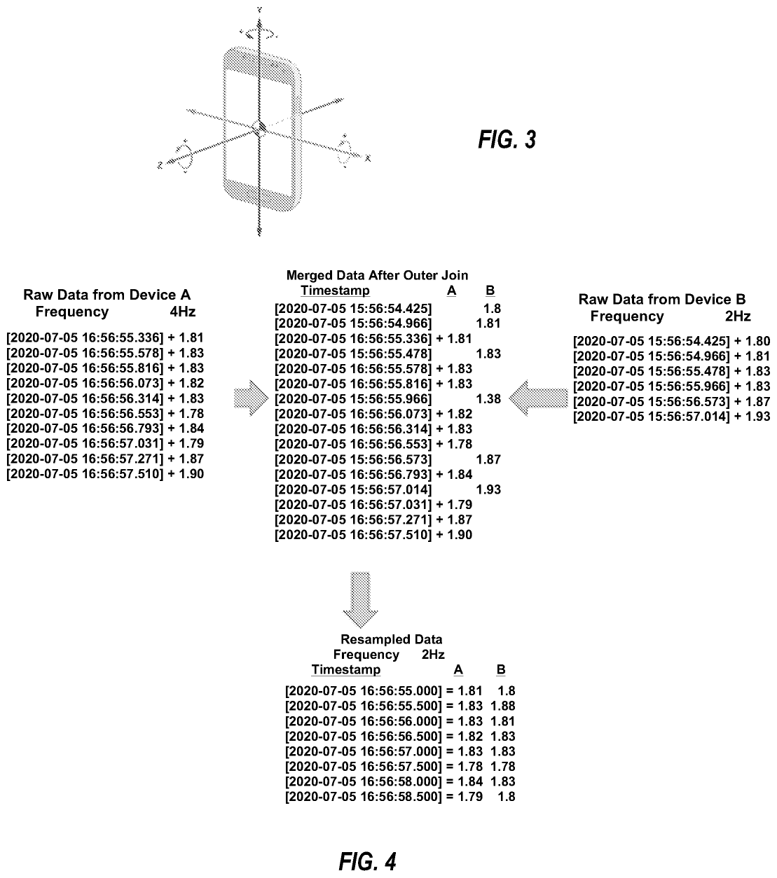

The vehicle speed, GPS trajectory, and IMU data can be stored in CSV format and used in the computational framework. The IMU data collected from the mobile devices can include three-axis (XYZ) readings of accelerometer, gyroscope, and magnetometer. This data can be used to describe the vehicle's motion when driving; therefore, it can be used to compute driving kinematics data, such as the driving path radius and the BBI angle. The three-axis readings of the IMU data can use the mobile device's local reference frame as the coordinate system, as shown in FIG. 3. The vehicle speed, GPS, and IMU data can be pulled and recorded using Android's recommended library functions. The accelerometer and magnetometer can measure the linear acceleration and magnetic field strength along each of the three axes, and the gyroscope can measure the angular velocity around each axis. Since the axes use the mobile device's local reference frames, they may not change with the smartphone's orientation; therefore, to use the IMU data from the mobile device to describe the vehicle's motion, it can be desirable for the mobile device to be fixed to the vehicle to keep the local reference frames of the mobile device and the vehicle aligned.

The camera of the mobile device can be used to record video during data collection of such data roadway image data that is useful for visualizing curve site conditions and data collection conditions; furthermore, the video log collected can also be used to detect and inventory existing traffic signs and other roadside assets, such as guard rails and retaining walls. The camera data collected using the AllGather application can be stored in many different video formats, such as MPEG4 video format.

The data collected by the various mobile devices can be transmitted to a remote location (such as a server) where the data can undergo various further processing and utilization steps as disclosed below.

### Module 2: Mobile Data Registration

Data registration is the procedure that aligns two or more data tables generated from different sensors or devices so that they share the same index column. For temporal data registration, the index column can be the timestamp, and for spatial data registration, the index column can be GPS points or the linear referencing distance on a roadway centerline. This section describes exemplary methods to temporally register data collected by different sensors in a single data collection run and spatially register the collected data in multiple data collection runs.

### Temporal Data Registration

In single runs of data collection, the mobile data collection can record readings from different sensors (GPS and IMU); even though the sensors share the same system clock, temporal data registration can still be needed due to different sensors possibly having different sampling rates. For example, typical Android devices can report GPS data at a 1-Hz sampling frequency, while IMU data can be refreshed at higher frequency (e.g., 10 Hz). This can result in data tables that have different lengths for the same time period. Therefore, to have correlated IMU data at each GPS point, and vice versa, both data tables can be resampled at a common timestamp with the same sampling frequency.

FIG. 4 illustrates how two data tables can be registered so that they share the same timestamps. The two data tables are first combined using the outer join operation, creating a super table that has one single timestamp column that contains the timestamps from both Raw Data from Device A and Raw Data from Device B. In the resulting Merged Data Table, the missing data (corresponding to the timestamp that only show up in one of the input tables) are created using linear interpolation. Finally, the Merged Data Table can be resampled at a fixed frequency (e.g., 2 Hz) using averaged values to produce the registered data table.

### Spatial Data Registration

In multi-run data collection, although the data collected in each individual run can be registered using temporal registration, the data from run to run may not share common timestamps. Therefore, to enable multi-run data aggregation, comparison, and analysis, spatial data registration can be used. A goal of spatial registration is to merge data tables so that the resulting table has a common GPS or spatial index column.

The process of spatial data registration can be very similar to the temporal registration; a difference is that the spatial information can be used as the common index. There can be two types of spatial information that can be used as a spatial index: GPS and linear referenced distance. A benefit of using GPS as the spatial index is that GPS data can be readily available from the collected data with no pre-processing needed. To get linear referencing distance, the GPS points may need to be projected onto a roadway centerline before the linear referencing distance can be computed. However, since curve inventory data can define a curve segment using the linear referencing distance of the PC and PT points, using the linear referencing distance can be useful for querying data related to a specific curve. Other than the difference in what is being used as the common index, the spatial data registration procedure can be essentially the same as the temporal data registration.

### Module 3: Driving Kinematics Data Calculation

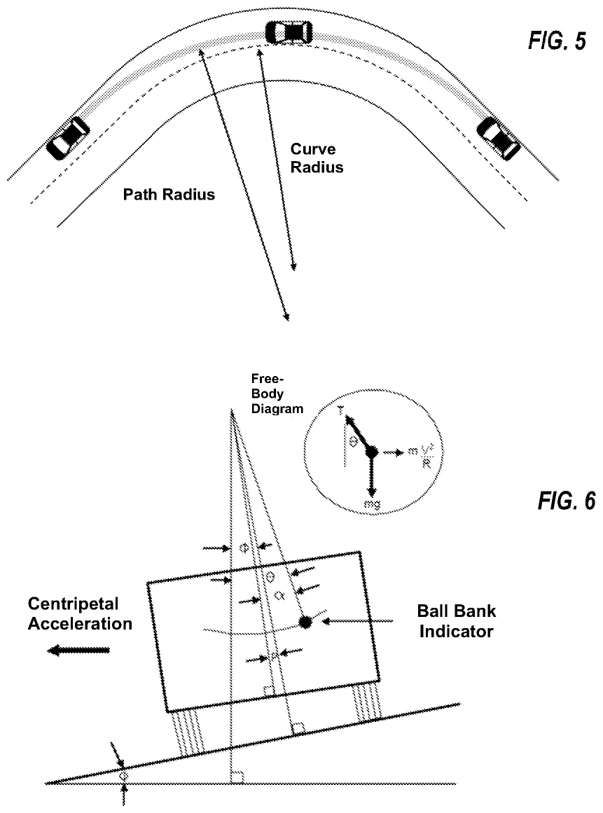

The kinematics data items included in the computational framework can include the path radius and BBI angle. It is worth noting that, in the exemplary computational framework shown in FIG. 2, there are two types of radius data: path radius and curve radius. In some embodiments, radius estimation can be an important step of the computational framework, and it can be important to understand the difference between the two types of radius data, as the path radius and curve radius are not used interchangeably for computing curve superelevation and determining an appropriate curve advisory. During cornering, as the vehicle wanders laterally within the lane, the curvature of the vehicle path can be different from the geometry radius of the curve. As illustrated in FIG. 5, an experienced driver may use lateral movement within the lane to “flatten” the curve so the path's curvature, the inverse of radius, is smaller than the curve centerline's curvature. Similarly, an inexperienced driver or a driver who makes a poorly executed turns by “jerking” the steering wheel may cause the path curvature to be temporarily larger than the curve centerline's curvature. Therefore, as used herein, the “path radius” reflects the driving trajectory, and the “curve radius” reflects the curved roadway geometry. A technical challenge is that the current practice of using curve radius is not a good representation of the actual path radius of the vehicle trajectory, and it can lead to error in superelevation calculation and increase sensitivity to driving behavior. Thus, in some embodiments, the path radius can be computed based on the actual vehicle trajectory to obtain a more accurate super-elevation computation.

### Path Radius Estimation Using Vehicle Speed and Angular Velocity

As illustrated in FIG. 5, path radius can be largely dependent on the steering input from the driver, and the path radius can easily change from one moment to another. Therefore, it can be desirable for the measurement of the path radius to reflect the vehicle's movement at a particular instant. The GPS trajectory may not reflect the general movement of the vehicle to certain degree for estimating path radius. However, given the fact that at least three GPS points are mathematically required for estimating the trajectory radius, meaning the result is not based on an instance but a period, and GPS accuracy may cause numerical instability in radius results when too few points are used, GPS points may be sub-optimal data for the path radius estimation. However, the IMU sensor of the smartphone can enable the capture of the dynamics of the vehicle. Assuming the vehicle is not spinning (oversteering) on the roadway, a method is proposed herein to obtain the path radius at any given time of the vehicle's motion using the IMU and GPS data collected by the mobile device.

### Curve Driving Kinematics

This section briefly describes the kinematics of curve driving to lay the foundation for BBI computation and superelevation computation using the BBI angle. To illustrate the kinematics of curve driving, this section largely references the Appendix A of Bonneson et al., “Development of Guidelines for Establishing Effective Curve Advisory Speeds,” FHWA/TX-07/0-5439 1, Texas Department of Transportation, Austin, Texas, 2007).

The Ball-Bank Indicator angle (BBI angle) refers to the movement of the ball measured in degrees of deflection, and this reading is indicative of the combined effect of superelevation, lateral (centripetal) acceleration, and vehicle body roll. FIG. 6 illustrates the relationship between the BBI angle (α), the lateral acceleration

$$( m \frac{{V}^{2}}{R} ) ,$$

superelevation angle (ϕ) and a vehicle's body roll (ρ).

The relationship shown in FIG. 6 is valid at any timestamp when a vehicle is on a curve, and this can be expressed as Equation 1:

$$\frac{{( 1.47 * V ( {t}_{i} ) )}^{2}}{{gR}_{p} ( {t}_{i} )} = tan ( α ( {t}_{i} ) + Φ ( {t}_{i} ) - ρ ( {t}_{i} ) ) \qquad Equation 1$$

where, α(tᵢ) is the ball-bank indicator angle at t=tᵢ, radians; Φ(tᵢ) is the superelevation angle at t=tᵢ, equitant to atan

$$( \frac{e}{100} ) ,$$

radians; ρ(tᵢ) is the body roll angle at t=tᵢ, radians; V(tᵢ) is the vehicle travel speed at t=tᵢ, MPH; and Rₚ(tᵢ) is the vehicle path radius at t=tᵢ, ft.

From FIG. 6, it can be seen that the angle θ is caused by the centripetal acceleration, while the superelevation supplies a portion of the acceleration; the remaining portion is supplied by the tire-pavement side-friction. As the angle ϕ represents the superelevation angle, we can define a side-friction angle (fᵣ) as the difference between the lateral acceleration angle and the superelevation angle (θ−ϕ). Therefore, the relationship in Equation 2 can also be derived.

$${f}_{r} = atan ( \frac{{( 1.47 * V ( {t}_{i} ) )}^{2}}{{gR}_{p} ( {t}_{i} )} ) - atan ( \frac{e ( {t}_{i} )}{100} ) \qquad Equation 2$$

It can also be seen in FIG. 6 that the BBI angle (α) is closely related to the side-friction angle (fᵣ) with the inclusion of the vehicle body roll angle (ρ).

$$α ( {t}_{i} ) = {f}_{r} ( {t}_{i} ) + ρ ( {t}_{i} ) \qquad Equation 3$$

The vehicle body roll can be caused by the lateral load acting on the vehicle; the amount of body roll under the same lateral load can be heavily dependent on the vehicle's suspension properties. Prior research revealed a constant roll rate can be found between side-friction angle and body roll angle. This relationship is shown in Equation 4, where k=roll-rate of the vehicle (rad/rad).

$$ρ ( {t}_{i} ) = k * {f}_{r} ( {t}_{i} ) \qquad Equation 4$$

Subsequently, the relationship between the BBI angle and the side-friction angle can be expressed as Equation 5.

$$α = {f}_{r} ( {t}_{i} ) * ( 1 + k ) \qquad Equation 5$$

And substitute side-friction angle in Equation 5 with Equation 2, Equation 6 can be derived.

$$α ( {t}_{i} ) = ( atan ( \frac{{( 1.47 * V ( {t}_{i} ) )}^{2}}{{gR}_{p} ( {t}_{i} )} ) - atan ( \frac{e ( {t}_{i} )}{100} ) ) * ( 1 + k ) \qquad Equation 6$$

It is worth noting that when a vehicle's roll rate is not available, assuming the vehicle roll rate equals to zero is equivalent to assuming no body roll when the vehicle is turning and using this assumption to estimate the side-friction angle from the BBI angle can exaggerate the side-friction angle. The amount of error from this assumption can increase as the BBI angle increases because the amount of error and the BBI angle have a positive linear relationship.

Equation 6 represents that when a vehicle's speed, path radius, and superelevation are known, the side-friction angle can be computed; it should have a (1+k) relationship to the BBI angle, and when the vehicle roll rate is also known, the expected BBI angle can be computed to validate the BBI angle as computed from the mobile device's BBI angle.

### BBI Angle Computation

After understanding the curve driving kinematics, it can be seen that the BBI angle can be the angle between the vehicle chassis' vertical direction and the net acceleration (including gravity) experienced by the vehicle. Thus, the BBI angle can be computed from two items in the mobile data—the vehicle chassis' vertical direction vector (\vec{G}) and the net acceleration vector (\vec{A}(tᵢ)). The chassis' vertical direction vector represents the direction of the net acceleration vector and if they are parallel, it would result in a “zero” BBI reading; thus, is referred to herein as the “zero vector.”

To obtain the “zero vector”, the data collection device can be first fixed to the vehicle's chassis (e.g., mounted to the windshield using a suction cup holder or any other means of securing the user device to the automobile), with the camera facing forward. In some embodiments, better readings can be obtained if the vehicle remains stationary on level ground for the first few seconds of a data collection run. During the stationary phase, the direction of the gravity can be measured by the accelerometers and used as the “zero vector.”

After the “zero vector” is obtained, the accelerometers can continuously measure the acceleration experienced by the vehicle, and the acceleration component perpendicular to the vehicle's driving direction can be used for computing the BBI angle.

### Module 4: Curve Geometry Data Computation

This section provides an exemplary computational method for calculating curve geometry data. The curve radius and deviation angle can be computed from the roadway's centerline or GPS data, and the curve superelevation can be computed from IMU data.

### Curve Radius and Deviation Angle Determination

In some embodiments, the curve radius and curve deviation angle of the roadway can be determined by fitting a circle on the geometric shape of the road centerline or GPS trajectory. This can comprise three primary steps: Step 1—Centerline or trajectory data smoothing; Step 2—Point of Curvature (“PC”) and Point of Tangent (“PT”) identification, and deviation angle estimation; and Step 3—Radius estimation.

Step 1 can comprise removing the outliers from the raw centerline and GPS data because the PC and PT identification can be highly relying on the change of heading, which can be computed by consecutive points rolling along the data. In some embodiments, a polynomial approximation with exponential kernel (PAEK) method can be used, which is a smoothing algorithm developed by ESRI ArcGIS software that provides a stable line-smoothing function. This function is developed based on the algorithm defined by Bodansky, et al., “Smoothing and compression of lines obtained by raster-to-vector conversion,” In International Workshop on Graphics Recognition, pp. 256-265. Springer, Berlin, Heidelberg, 2001.

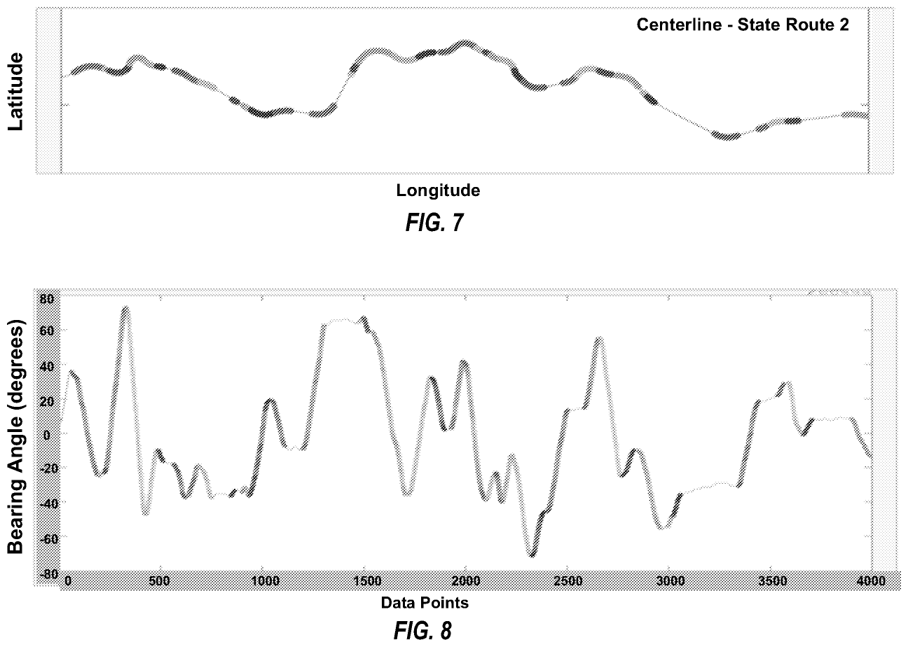

Step 2 can comprise identifying the PC and PT based on the change of heading. A vehicle's heading starts changing at PC and stops at PT. The change of heading can be computed as the difference of the bearing angle between consecutive points. FIG. 7 shows the centerline data with extracted curves on State Route 2 (SR-2), and FIG. 8 shows the bearing angle with extracted curves correspondingly.

Step 3 can comprise fitting a circle between PC and PT to estimate the radius for each extracted curve. In some embodiments, the Kasa method can be used (Kasa, I., “A Circle Fitting Procedure and Its Error Analysis,” IEEE Transactions on Instrumentation and Measurement IM-25, no. 1 (1976): 8-14. https://doi.org/10.1109/TIM.1976.6312298), which is a widely used least-squares circle geometric fitting method that is based on finding the minimum distances from the given points to the geometric feature to be fitted.

### Curve Superelevation Determination

From Equation 6, the computation for superelevation can be derived as Equation 7. The relationship in Equation 7 can be based on any arbitrary instance of the vehicle's motion state; therefore, the path radius at a timestamp (Rₚ(tᵢ)) can be used to represent the vehicle's motions state.

$$e ( {t}_{i} ) = 100 * tan ( atan ( \frac{{( 1.47 * V ( {t}_{i} ) )}^{2}}{{gR}_{p} ( {t}_{i} )} ) - \frac{α ( {t}_{i} )}{( 1 + k )} ) \qquad Equation 7$$

A positive BBI angle can have a positive sign when the BBI reading indicates the “steel ball” is swinging towards the outside of the curve, and a negative sign can be used when the “steel ball” swings toward the inside of the curve.

### Calibration Method for Vehicle Roll Rate Estimation

As shown in Equation 7, the vehicle speed, path radius, BBI angle, and vehicle roll rate can be used to determine a curve's superelevation. The vehicle speed, path radius, and BBI angle can either be directly obtained or computed from the collected mobile data. The vehicle roll rate (k) may not be directly measured by the mobile device. As discussed in the Curve Driving Kinematics section above, assuming k=0, reasonable superelevation results may still be obtained, but the error in superelevation may continuously grow with higher and higher side-friction angles. Therefore, as the driving speed increases, the superelevation results can be more and more underestimated. This technical challenge can hinder the use of low-cost smart mobile devices and the leveraging of existing fleets (while engineers are undertaking their daily operations) because driving speeds and trajectories may not be consistently smooth.

While the vehicle roll rate can be measured mechanically, it may be impractical to require all data collection vehicles' roll rates to be mechanically measured. Therefore, described herein are two calibration methods that estimate vehicle roll rate using mobile data collection without any mechanical tests. The first method can utilize a known measurement of the superelevation, while the second method may not utilize a known superelevation, though it can utilize multi-run data collection on the same curve at different driving speeds.

Calibration Using Curves with Known Superelevation

As shown in Equations 2 and 5, the side-friction angle (fᵣ) can be determined with the known vehicle speed, path radius, and superelevation. The resulting side-friction angle (fᵣ) can also have a (1+k) relationship with the measured BBI angle. Therefore, when the superelevation is known, the side-friction angle can be calculated using the known superelevation for locations where BBI angle data was measured, the side-friction angle and BBI angle can show a linear relationship with the slope equal to (1+k).

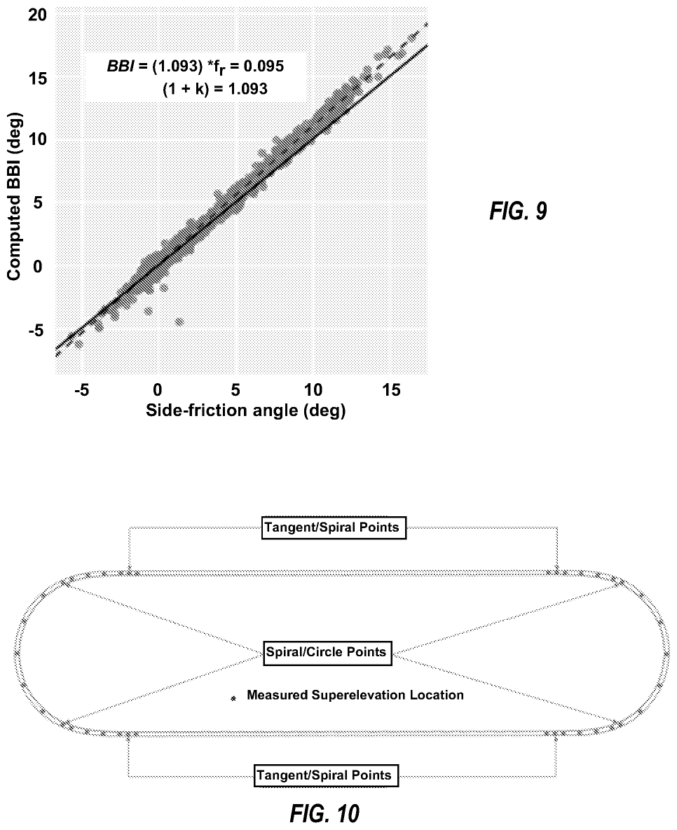

FIG. 9 shows an example outcome from tests performed on the National Center of Asphalt Technology (NCAT) test track. The superelevation was manually measured at 100-ft-stations on spiral sections and 200-ft stations on constant radius sections. The measured superelevation was combined with collected mobile data to compute the side friction angle and showed a good linear relationship with the computed BBI with a slope equal to 1.093, indicating the data collection vehicle had a roll rate of 0.093 rad/rad. Detailed results of using this calibration method are presented in the validation section below.

Calibration Using Curves with Unknown Superelevation

Manually measuring curve superelevation might be impractical for agencies without access to a closed facility. Accordingly, disclosed herein is a calibration method that does not require measurement of superelevation. Multiple runs of data can be collected at different speeds on the same curve with unknown superelevation. This method can work because the superelevation does not change for the same curve between multiple passes. Although the true superelevation is unknown, if vehicle roll rate is estimated correctly, the computed superelevation can be similar between runs at different speeds.

The data presented in FIG. 9 were collected at five different speeds in 5 MPH increments. Using the same data, but without using the measured superelevation, this calibration method can find a best-fit vehicle roll-rate equal to 0.095 rad/rad, similar to the roll-rate found in using the “Known Superelevation” method of 0.093. Detailed analysis of this calibration method is presented in the validation section below.

### Module 5: Advisory Speed Determination

As described below, the advisory speed for a curve can be determined based on single or multiple run data collection, in accordance with various embodiments of the present disclosure.

Advisory Speed Determination from Single-Run Data Collection

Accurate computation of the curve advisory speed can be critical to driver safety because it determines the type and placement of warning signs. If the computed advisory speed is too high, drivers may be unprepared for the sharpness of a curve. If the computed advisory speed is too low, drivers will lose their trust in the curve warning signs and begin disregarding them, ultimately putting themselves in danger. Equation 8 shows an exemplary calculation for determining the curve advisory speed. Note that curve radius (R_{c}), not path radius (Rₚ), can be used in this calculation, as the advisory speed can be dependent on the curve geometry, not a particular driver during a particular data collection run.

$${V}_{adv} = \sqrt{15 * ( \frac{e}{100} + {f}_{max} ) * {R}_{c}} \qquad Equation 8$$

Where, fₘₐₓ can be the maximum allowed side friction factor by the advisory speed criteria; R_{c} can be the curve radius, ft; and V_{adv} can be the advisory speed limit, MPH.

The MUTCD 2009 edition defines the advisory speed criteria as follows: 16 degrees of ball-bank for speeds of 20 MPH or less; 14 degrees of ball-bank for speeds of 25 to 30 MPH, and 12 degrees of ball-bank for speeds of 35 MPH and higher. This corresponds to the maximum allowed side friction factors as follows: 0.287 for speeds of 20 MPH or less; 0.249 for speeds of 25 to 30 MPH; and 0.212 for speeds of 35 MPH and higher. For single-run collected data, the advisory speed can be calculated for each data point along a curve, and the lowest advisory speed result can be reported as the advisory speed of the curve.

Advisory Speed Determination from Multiple-Run Data Collection

For multi-run collected data, each individual data collection run can be processed using the proposed computational framework. Since an advisory speed can be determined based on the minimum advisory speed results along the curve, any noise or unreliable data can almost always lower the overall advisory speed for the curve; therefore, for multi-run data processing, the highest advisory speed from the individual single runs can be used as the advisory speed of the curve. In addition, variations between individual runs can be used as indicators for flagging unreliable results that are recommended for data re-collection. The outcome of the final advisory speed can be determined by comparing the advisory speeds derived from the multi-run data. Besides choosing the highest computed advisory speed among the multi-run data as the final design advisory speed, a confidence level (L, M, and H) of the computed advisory speed is recommended based on the variability among the computed single-run advisory speeds. This confidence level is a qualitative indicator. For a low confidence level (L), it means that there is a high variability among different runs of data. In some cases, re-collecting the data in the field is performed because of high data variability. A high confidence level indicates that there is a high consistency on different runs of measurements. A case study on multi-run analysis using data collected on Georgia State Route 17 is presented below. In some embodiments, the multiple-run data being used can be based on the advisory speed outcome. The rich data collected in the multi-run mobile data collection still has potential to be used for other analyses that can be used to determine data quality and driver behavior.

### Validation of Proposed Computational Framework Using Mobile Data Collection Devices

This section presents the validation tests and results of an exemplary computational framework for curve safety assessment using mobile data collection devices. Two tests are presented-a repeatability test to perform a preliminary evaluation of the mobile sensor's repeatability across different devices and a validation test to comprehensively evaluate the performance using mobile devices in the proposed computational framework. The validation test was performed at National Center for Asphalt Technology (NCAT) closed test track, with the goal of validating the proposed method using different driving speeds and driver inputs. This section evaluates the computed results of the radius, BBI angle, superelevation, and advisory speed. Using the proposed method to evaluate the feasibility of estimating superelevation with low-cost smartphones, the validation test was centered around comparing the computed superelevation results with the manually measured track superelevation. There at least two reasons for this design. First, superelevation can be an important element in curve geometry information needed to determine appropriate curve advisory speed. Its accuracy can be dependent on other computed elements, such as path radius and BBI angle; therefore, an accurate superelevation estimation may depend on accurate estimation of both the path radius and the BBI angle. Second, superelevation, as part of the curve geometry, can be physically measured and does not change during the test with different travel speeds or different driver inputs. This makes the evaluation of the exemplary method disclosed herein straightforward, as data collected from different data collection runs can be compared to the same ground reference superelevation values.

### Repeatability Test of the Mobile Sensors

The reliability and repeatability of mobile sensors can be fundamental to the use of mobile devices for curve safety assessment data collection. In this test, a goal is to evaluate the repeatability of the IMU data collected by multiple mobile devices in the same data collection environment. The test was designed to place a number of mobile devices in the same orientation within the data collection vehicle and record the IMU data as the vehicle was driven. The test was set up by placing three smartphones on the dashboard. Three different smartphones were used: the Xiaomi Redmi Note 4 White (Xiaomi 1), Google Pixel 3a (Pixel), Xiaomi Redmi Note 4 Black (Xiaomi 2).

Since these smartphones were all placed in the same vehicle during the same data collection, the data collection environment was identical for all the devices. In other words, if the data collected by different devices was perfectly repeatable, the IMU data collected by the different devices should have a perfect correlation among the devices.

The IMU data in each device reports the linear acceleration, angular velocity, and magnetic fields in all XYZ directions. However, in some embodiments, the computational methods only utilize linear acceleration and angular velocity data from the IMU. For each of the sensor readings, the normalized cross-correlation was compared for each pair of devices. Normalized cross-correlation measures the similarity between two signals and is bounded between −1 and 1; a correlation of 1 indicates the signals have a perfect similarity. Table 1 shows the normalized cross-correlation of different sensor data between different pairs of devices.

TABLE 1
Correlation of collected sensor data between different devices.

| | Normalized Cross-Correlation | | |
|---|---|---|---|
| | Xiaomi1 & | Xiaomi1 & | Xiaomi2 & |
| Collected Data | Xiaomi2 | Pixel | Pixel |
| Linear acceleration X | 0.9805 | 0.9638 | 0.9961 |
| Linear acceleration Y | 0.8431 | 0.9225 | 0.9845 |
| Linear acceleration Z | 0.9998 | 0.9997 | 0.9997 |
| Angular velocity X | 0.9921 | 0.9436 | 0.9516 |
| Angular velocity Y | 0.9948 | 0.8000 | 0.8036 |
| Angular velocity Z | 0.9999 | 0.9996 | 0.9997 |

From the results, it can be seen that the majority of the sensor data has a high (more than 0.98) correlation, indicating results computed from the data collected by one mobile device can be repeated by another mobile device. Among different sensors, the angular velocity in the Y direction showed the lowest normalized cross-correlation value, which is likely due to the way the devices were set up; the Y-axis of the devices was aligned with the driving direction, and in typical driving conditions, the vehicle does not rotate significantly around this axis. Therefore, there was no significant rotation signal for the sensor to collect and the correlation score was largely impacted by the random noise of the sensor. Given that the sensor qualities within the same device are generally similar, the repeatability of the angular velocity Y should be similar to other axes if the device was orientated differently in the vehicle.

### Validation Test of an Exemplary Method

The purpose of the validation test was to evaluate the feasibility of an exemplary method which uses mobile devices for curve safety assessment data collection and analysis. This test focused on validating the superelevation estimation accuracy. Superelevation can be an important data item for determining the appropriate curve advisory speed, and superelevation is part of the curve geometry that can be physically measured to evaluate the superelevation estimation accuracy. Evaluation of other computed data items, such as the BBI angles and advisory speed limit, was expanded from the superelevation by using manually measured superelevation to back-calculate the expected values.

### Validation Test Location National Center for Asphalt Technology (NCAT)

The National Center for Asphalt Technology (NCAT), located in Auburn, Alabama, has a closed facility with a 1.7-mile oval test track for accelerated pavement tests. NCAT's test track is an ideal site for performing the validation test, as the superelevation can be manually measured without the need for traffic control, since the test track is not on public roads. In addition, horizontal alignment and cross-section drawings are available to provide curve geometry information. However, since the test track has been repaved multiple times after its initial construction, the superelevation values were manually measured throughout the curve to obtain the current superelevation on the test track.

### Validation Test Design and Test Procedure

As stated above, while the purpose of the test was to validate the computed data items in an exemplary method, the design of the validation was focused on using superelevation as the physically measurable curve geometry to validate the superelevation computation; the validation also used the measured superelevation to back-calculate the expected values for validating the BBI angle and advisory speed computation. In addition, the validation of the curve radius estimation was done by comparing the estimated curve radius to the radius documented in the track design drawing.

### Manual Superelevation Measurements

To obtain detailed superelevation data on the NCAT test track, superelevation was measured throughout the curves. The curves on the NCAT test track are composed of one constant radius portion in the middle of the curve with a radius of 476 feet, and two spiral proportions at the beginning and the end of the curve to transition to the tangent parts of the track. The superelevation data was measured every 200 feet on the constant radius section and every 100 feet on the spiral sections; additional measurements were made at transition points between tangent and spiral sections and between spiral and circle sections. FIG. 10 shows the locations on the NCAT test track where superelevation was manually measured.

At each location shown in FIG. 10, superelevation measurements were manually taken using an 8-ft straightedge and a digital level; three measurements were taken at each location with 1 ft between each location. Averages of the three measurements were used to represent the track superelevation. The digital level used can provide slope readings down to 0.1% slope.

According to the design drawings, the test track was designed to have a 15% slope on fully superelevated sections of the curves; the manually measured results showed the current test track has a 14-16% slope on fully superelevated sections.

### Driving Speed and Driving Behavior

The validation test was performed by making multiple runs of data collection at different driving speeds and with different driving behaviors. Different driving speeds were performed using the vehicle's cruise control system. The test was performed at five different speeds, ranging from 30 MPH to 50 MPH in 5 MPH increments. At each speed, five laps were driven to evaluate the repeatability of the calculation. Different driving behaviors were introduced. For example, the driver drove as smoothly as possible through the curve to represent “good/optimal” driving behavior; on the last lap, the driver made sudden steering adjustments, which made the vehicle wander over the lane, to mimic “bad/undesired” driving behaviors.

### Data Collection Devices and Setup

Three mobile devices were used during the validation test, two Android smartphones and a GoPro camera that has internal GPS and IMU sensors. Two smartphones were equipped to evaluate the impact of different mounting methods as Smartphone 1 was mounted with a clamp mount to the dashboard, and Smartphone 2 was mounted with a suction cup that has an extension arm to secure the device. The inclusion of the GoPro camera was to evaluate the impact of the different sensors, as the GPS and IMU sensors in the GoPro camera have a higher sampling frequency than the smartphones; also, the quality of the sensors might be different in the GoPro. In addition, the Rieker inclinometer was included in the test to represent commercial solutions for BBI angle measurement.

### Test Procedure

The following procedure was followed to validate the test at NCAT.

Task 1: Survey the superelevation on the NCAT test track. Using a measuring wheel, locate key reference points (spiral-tangent point and circle-spiral point). Starting from the mid-point of each curve, measure the superelevation at the following distance away from the mid-point. Distance to mid-point where superelevation is measured: 0 ft, 200 ft, 400 ft, 543.7 ft, 600 ft, 700 ft, 800 ft, 900 ft, 951.7 ft, 1000 ft, and 1100 ft. At each location, measure superelevation three times with each measurement spaced 1 ft apart. Report the average of the three measurements.

Task 2: Collect mobile data (in motion). Set up the data collection devices in the vehicle (Chevy Tahoe SUV). Before the start of each data collection, park the vehicle on the tangent section, preferably riding the centerline to balance the cross-slope. All test devices will start the recording at the same time. After recording starts, stand by for at least 10 seconds for zeroing the BBI measurements. Proceed with the following data collection runs in Table 2. Restart the recording after each run.

TABLE 2
Description of the data collection runs.

| | | Number of Laps |
|---|---|---|
| | | (Good Driving + Bad |
| Run Number | Speed (MPH) | Driving) |
| Run 1 | 30 | 4 + 1 |
| Run 2 | 35 | 4 + 1 |
| Run 3 | 40 | 4 + 1 |
| Run 4 | 45 | 4 + 1 |
| Run 5 | 50 | 4 + 1 |
| Total | | 20 + 5 |

### Validation Test Results—Curve Radius Calculation

The NCAT test track has two main curves (West Curve and East Curve) that have the same curve radius. To validate the proposed method for computing curve radius, the estimated curve radius is compared to the curve radius in the design drawings.

The exemplary method tested utilizes the use of the roadway centerline for extracting the curve radius. For this test, Google Earth was used to extract the centerline of the test track. Using the “add path” tool, the centerline of the test track was manually traced on the satellite map (using the pavement marking as reference).

After obtaining the centerline, the curve radius was computed by using the curve sections on the roadway centerline and using the Kasa fit method to estimate the least square fit circle for radius estimation. The estimated curve radius using the proposed method showed a circular radius of 478.1 ft for the West Curve and 481.4 ft for the East Curve. The curve radius documented in the design drawing has a radius of 476 ft for the circular section of the curves. This shows that using the exemplary method can very reasonably estimate the curve radius using the roadway centerline.

Validation Test Results—Superelevation Calculation without Body Roll Calibration

As shown in Equation 7, the exemplary superelevation calculation method can use the driving speed, path radius, and vehicle roll rate. However, the roll rate of the vehicle may not be readily available. In the case of unavailable roll rate information, the superelevation can be approximated by assuming the body roll is small enough that the roll rate constant is equal to zero. This assumption may be reasonable for low travel speeds; however, as/if a vehicle travels faster on curves, the amount of body roll increases; this could cause the assumption to be less accurate than the actual condition. This section presents the accuracy level of superelevation calculation at different driving speeds; it assumes there is no vehicle body roll.

### Superelevation Results at Different Driving Speeds

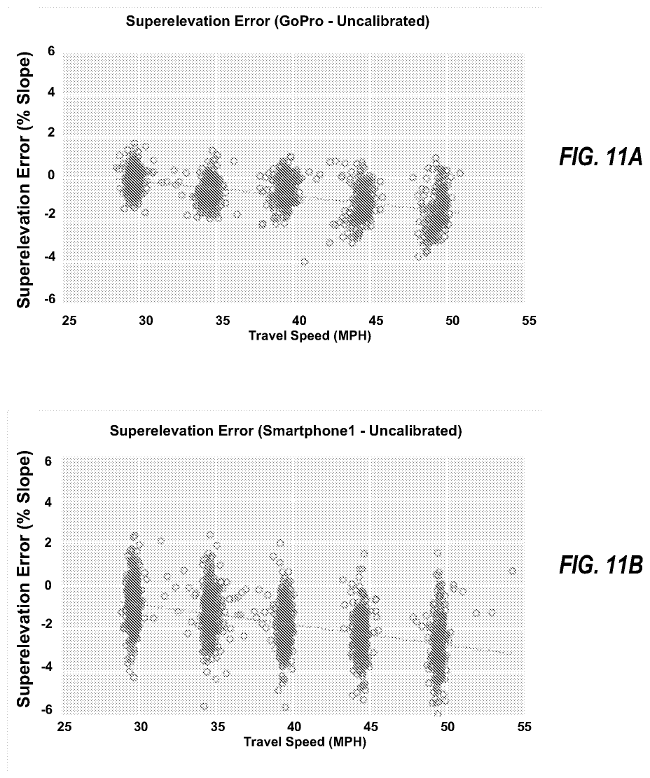

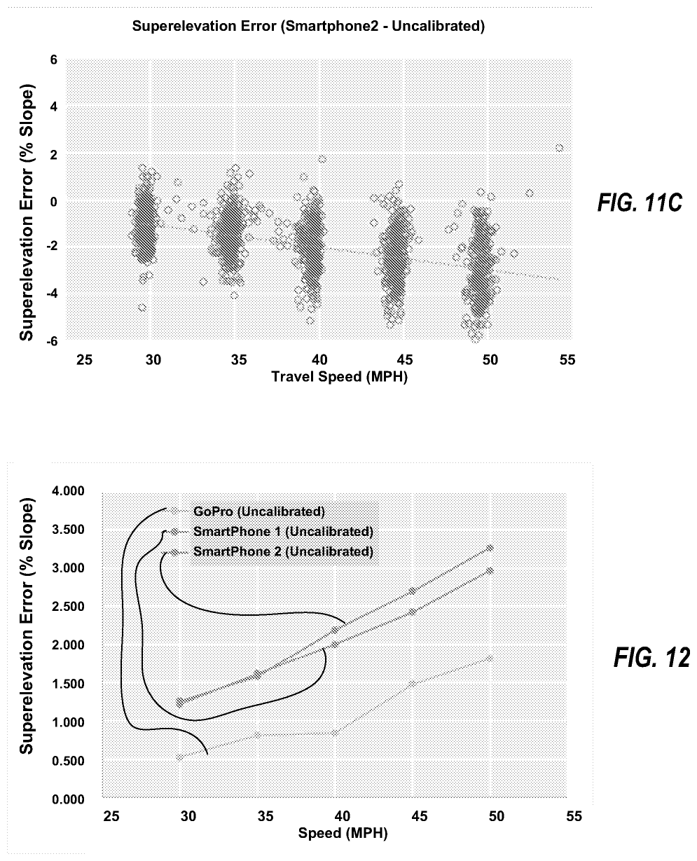

FIGS. 11A-C show the error of uncalibrated superelevation results that were calculated from the three data collection devices. As shown in the charts, at any given speed, the variation in the error (amount of vertical spread) remained similar for all devices, while the results from the GoPro showed the random error is lower in GoPro than in the smartphones. In addition, the bias of the superelevation error has a downward trend with increasing speed. This indicates that, without calibration, the calculation tends to underestimate the superelevation of the roadway when the vehicle is traveling at high speed. The amount of underestimation has a positive relationship to the travel speed. This behavior is expected and can be explained by Equation 7. When assuming no vehicle body roll, the large BBI angle (typically from higher driving speed) can cause the superelevation results to be lowered.

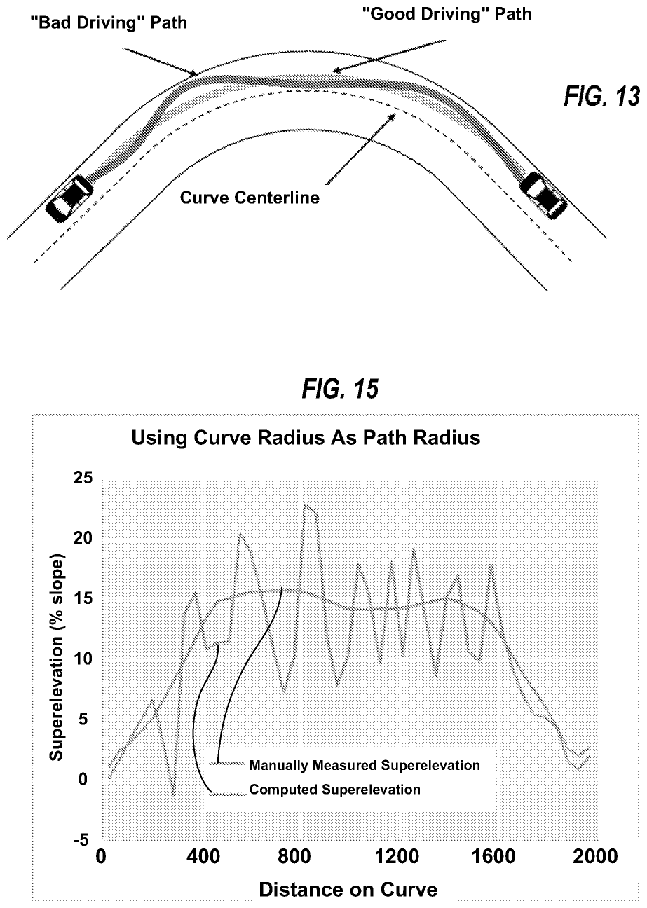

Table 3 summarizes the root-mean-square error (RMSE) of the uncalibrated superelevation results categorized by vehicle speed, mobile device, and driving behavior. The superelevation RMSE is plotted in FIG. 12. The results show that the GoPro data produced more accurate results than those from smartphones. Smartphone 1 is slightly more accurate than Smartphone 2, which shows that the mounting mechanism for Smartphone 1 (mounted with dashboard clamp) may improve the accuracy but only slightly. Finally, poor curve driving (shown in FIG. 13) does reduce the accuracy of the superelevation calculation. However, with the exemplary method tested, the superelevation error level will increase by less than 0.5% slope.

TABLE 1
RMSE of uncalibrated superelevation results.

| | RMSE of | | RMSE of | | RMSE of | |
|---|---|---|---|---|---|---|
| | Superelevation | | Superelevation | | Superelevation | |
| | (GoPro) | | (Smartphone 1) | | (Smartphone 2) | |
| | Driving Style | | | | | |
| | Good | Bad | Good | Bad | Good | Bad |
| 30 MPH | 0.525 | 0.872 | 1.216 | 1.401 | 1.255 | 1.524 |
| 35 MPH | 0.808 | 1.244 | 1.611 | 1.929 | 1.578 | 1.850 |
| 40 MPH | 0.839 | 1.205 | 1.999 | 2.334 | 2.189 | 2.575 |
| 45 MPH | 1.476 | 1.683 | 2.423 | 2.590 | 2.695 | 2.668 |
| 50 MPH | 1.817 | 2.474 | 2.965 | 3.372 | 3.266 | 3.948 |
| Overall | 1.093 | 1.496 | 2.043 | 2.325 | 2.197 | 2.513 |

### Importance of Using Path Radius for Superelevation Calculation

As discussed above in the validation test design, the validation test also introduced different driving behaviors to evaluate the robustness of the exemplary method. FIG. 13 illustrates the different driving behaviors used during the validation test.

For superelevation calculation, the radius of the vehicle's path was used, and, generally, the curve's centerline radius is a good approximation of the path radius. As shown in FIG. 13, the curvature of the “good driving” path is, generally, similar to the curvature of the centerline. However, some driving behaviors, such as frequent wandering within the lane and “jerking” the wheel when turning, may cause the curvature of the driving path to be drastically different from the centerline. Therefore, at any point during cornering, the superelevation calculation at that point can use the speed, BBI angle, and path radius corresponding to the vehicle at that moment.

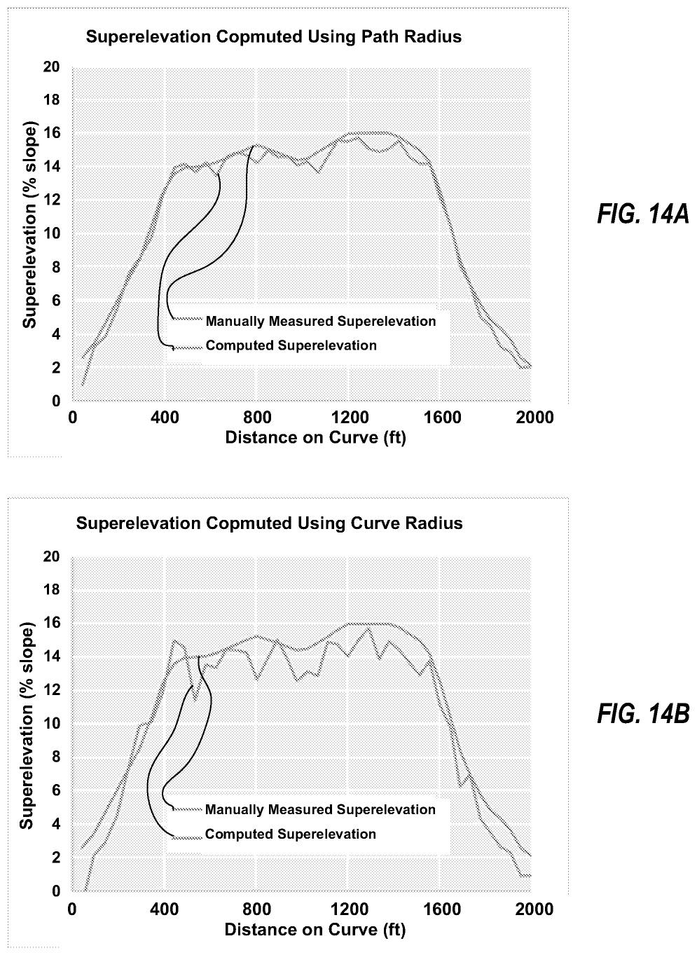

The example in FIGS. 14A-B shows that in “good driving” cases, using the curve radius to approximate the path radius can still result in acceptable superelevation estimation. However, when “bad driving,” such as wheel jerking and wandering occurs, the curve radius may no longer describe the vehicle's driving path, leading to significant error in superelevation estimation (shown in FIG. 15).

### Performance Comparison of Different Path Radius Calculation Methods

It would be logical for the GPS that captures the vehicle's trajectory to be used to compute the path radius. However, given the GPS sampling rate in smartphones (typically 1 Hz) and the accuracy of GPS (typically about 15 ft), the subtle movement caused by steering input may not be able to be captured. In order to get the path radius at a particular GPS point, the neighboring points may also be needed for the least square fitting; therefore, the path radius computed from the GPS may not represent the curvature of the path at an instant, but the averaged curvature over a small period.

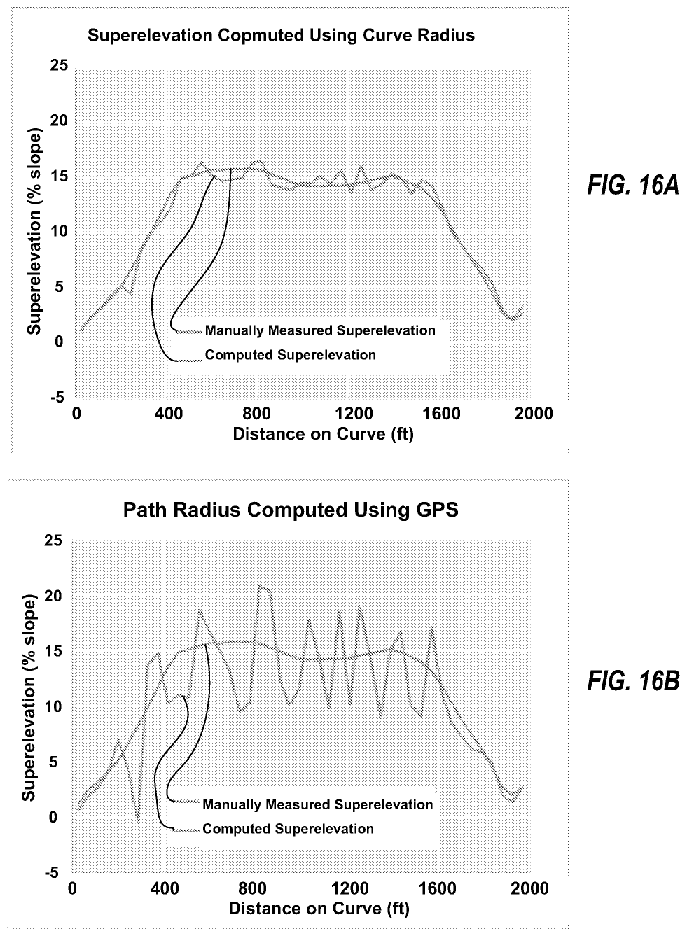

With this in mind, the exemplary method can measure the path radius from the angular velocity and vehicle speed. FIGS. 16A-B show an example of a “bad driving” case in which the difference in superelevation measurement performance between using the path radius estimated from GPS and using the path radius estimated from the gyroscope.

From the results, it can be seen that there is still a significant amount of error in the GPS method. In the case of calculating the path radius from the gyroscope and vehicle speed, the curvature at every point of the cornering process, the radius was captured accurately, leading to no significant performance difference compared to the “good driving” cases.

### Validation Test Results—Vehicle Roll Rate Estimation

As seen in the uncalibrated superelevation results, the vehicle speed can have an impact on the accuracy results, as higher speed can introduce more vehicle body roll thus making the results less accurate. The errors introduced can be minimized if the vehicle roll rate is available. However, most vehicle owners may not know their vehicle's roll rate; the roll rate, therefore, can be measured to calibrate the superelevation results.

As the exemplary methods to estimate vehicle roll rate from collected mobile data are discussed above, this section presents the results of the exemplary methods using data collected during the NCAT test.

TABLE 4
Roll-rate estimation of the data collection vehicle

| | Estimated Vehicle Roll Rate (rad/rad) | | | | |
|---|---|---|---|---|---|
| | | | | | Stan- |
| | | | | Average | dard |
| Estimation | | Smartphone | Smartphone | Roll | Devia- |
| Method | GoPro | 1 | 2 | Rate | tion |
| With Known | 0.0918 | 0.0958 | 0.1089 | 0.0988 | 0.0073 |
| Superelevation | | | | | |
| With Unknown | 0.0938 | 0.1019 | 0.1202 | 0.1053 | 0.0110 |
| Superelevation | | | | | |

Roll Rate Estimation with Known Superelevation

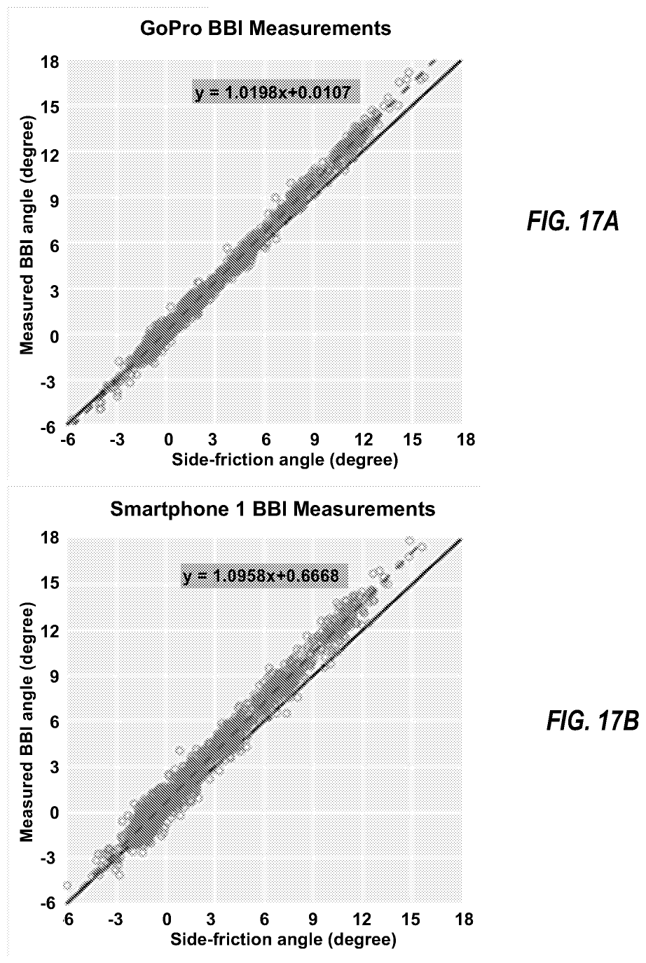

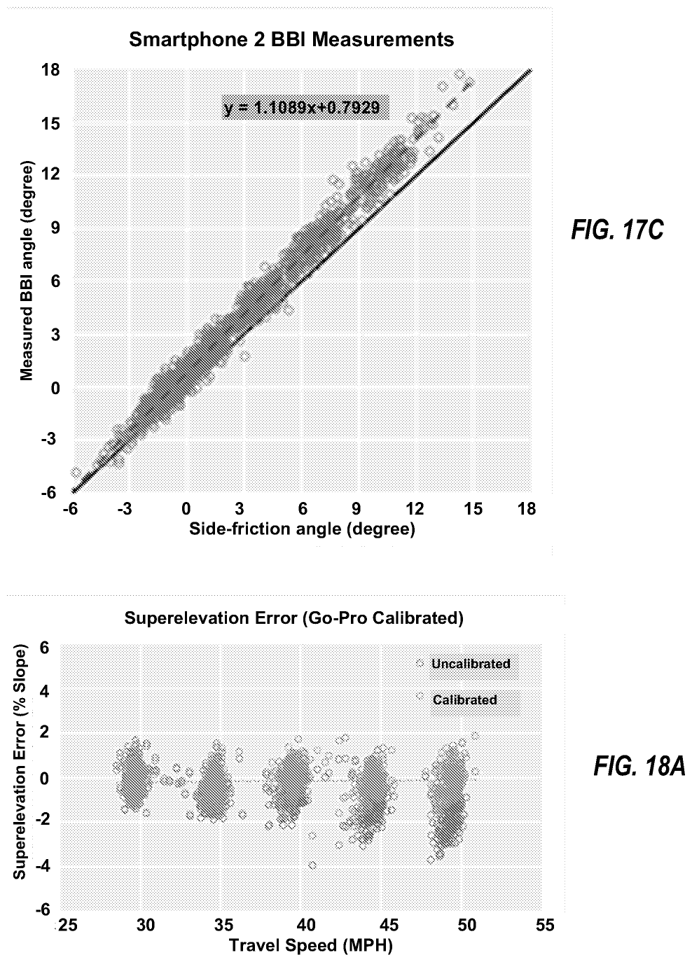

As mentioned in the previous section, this exemplary method uses the measured superelevation to compute the side-friction angle during data collection, and by comparing the relationship between the side-friction angle (calculated using Equation 2) and the measured BBI angle (shown in FIG. 17) to estimate the roll rate of the vehicle.

Roll Rate Estimation with Unknown Superelevation

While the benefit of the roll rate estimation with the known superelevation is simple in its computation, detailed superelevation measurements might not be available in most circumstances. Therefore, as mentioned in the previous section, when the superelevation is not available, an alternative approach can be to use the vehicle to collect mobile data on the same curve with different speeds. Using the data collected at NCAT with five different speeds (30 MPH-50 MPH), and with two out of five laps, the vehicle's roll rate was estimated without using the measured superelevation. The results of the estimations are shown in Table 4, and it can be seen that the estimations are also similar between different devices. There is a slight increase in the standard deviation compared to the “known superelevation” method.

Although this method for estimating the vehicle roll rate can utilize multiple runs of data collection at different speeds, this approach might be more practical to implement since it does not require any knowledge of the curve geometry, and the repeatability of this method is similar to the “known superelevation” method.

TABLE 5
Estimated roll rate with different data collection strategies.

| | Number of | Total | | | |
|---|---|---|---|---|---|
| | Runs at | Number of | Estimated Roll Rate | | |
| | each speed | Runs | GoPro | Smartphone 1 | Smartphone 2 |
| Two speeds @ | 2 | 4 | 0.1059 | 0.1802 | 0.1593 |
| 5 MPH | | | | | |
| increment | | | | | |
| Two speeds @ | 2 | 4 | 0.0984 | 0.1064 | 0.1202 |
| 10 MPH | | | | | |
| increment | | | | | |
| Two speeds @ | 2 | 4 | 0.1042 | 0.0995 | 0.1085 |
| 15 MPH | | | | | |
| increment | | | | | |
| Two speeds @ | 3 | 6 | 0.0858 | 0.1776 | 0.1662 |
| 5 MPH | | | | | |
| increment | | | | | |
| Two speeds @ | 3 | 6 | 0.0912 | 0.1170 | 0.1328 |
| 10 MPH | | | | | |
| increment | | | | | |
| Two speeds @ | 3 | 6 | 0.0946 | 0.1080 | 0.1146 |
| 15 MPH | | | | | |
| increment | | | | | |
| Three speeds @ | 2 | 6 | 0.0890 | 0.1186 | 0.1129 |
| 5 MPH | | | | | |
| increment | | | | | |
| Four speeds @ | 2 | 8 | 0.0925 | 0.1069 | 0.1189 |
| 5 MPH | | | | | |
| increment | | | | | |

To investigate the recommended speed difference between runs and the number of runs at each speed for this roll rate estimation method, Table 5 shows the estimated roll rate using different data collection strategies. We can see that while more runs generally improve the method's repeatability, the speed difference between the highest and lowest data collection speed can play a more important role in the result's repeatability. Therefore, if the method is formalized as a calibration method, performing the calibration test at two different speeds and repeating each speed two times can be enough to produce a reasonable roll rate estimation; repeating each speed three (or more) times would produce an estimation with higher confidence.

Validation Test Results—Superelevation Calculation with Body Roll Calibration

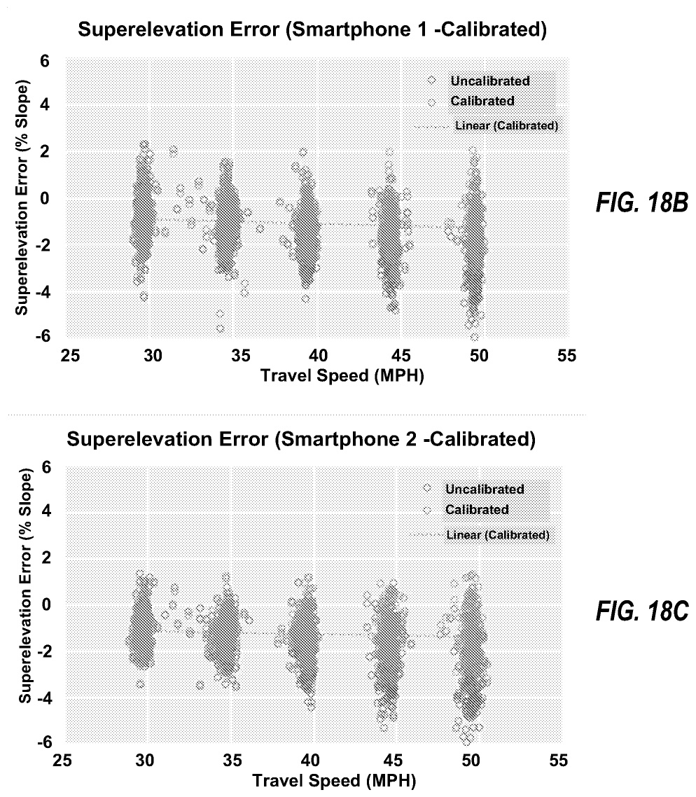

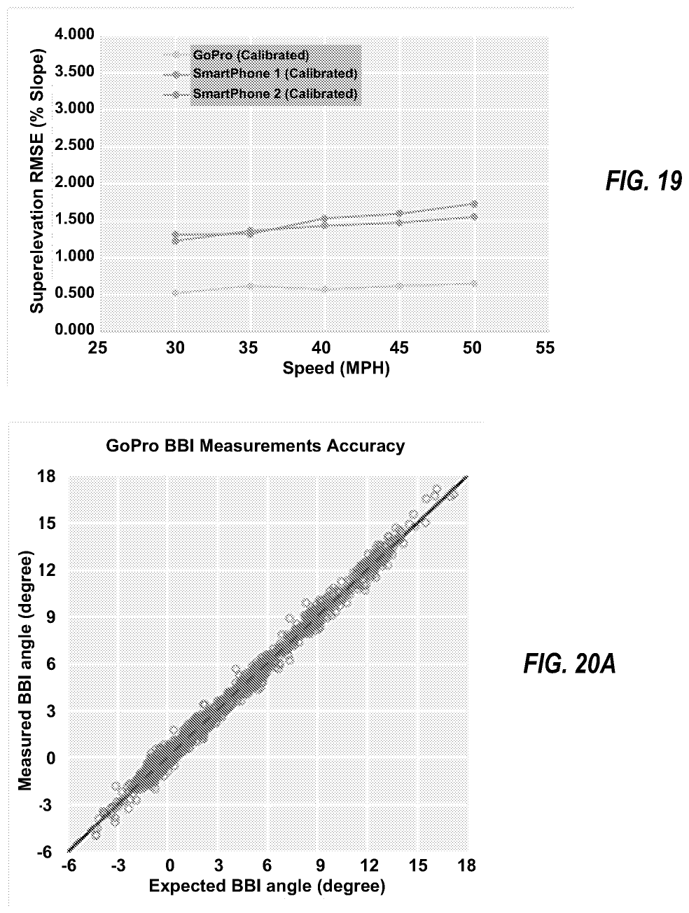

Using the vehicle roll rate estimated in an exemplary method, the superelevation results can be calibrated to compensate for the impact of vehicle body roll. FIGS. 18A-C show the comparison of the superelevation error before and after calibration using the estimated vehicle roll rate. Table 6 summarizes the RMSE of the uncalibrated superelevation results and is separated based on vehicle speed, mobile device, and driving behavior. The superelevation RMSE is plotted in FIG. 19. The results show, after calibration, the superelevation measurement accuracy may no longer be impacted by the travel speed. The device's random noise level (vertical spread at each speed) can be unaffected by the calibration.

The validation results show that after calibration, the GoPro camera is able to measure superelevation with 0.598% slope accuracy, and the smartphones can achieve a measurement accuracy between 1.4-1.5% slope.

TABLE 6
RMSE of Calibrated superelevation results.

| | RMSE of | | RMSE of | | RMSE of | |
|---|---|---|---|---|---|---|
| | Superelevation | | Superelevation | | Superelevation | |
| | (GoPro) | | (Smartphone 1) | | (Smartphone 2) | |
| | Driving Style | | | | | |
| | Good | Bad | Good | Bad | Good | Bad |
| 30 MPH | 0.522 | 0.695 | 1.226 | 1.366 | 1.318 | 1.501 |
| 35 MPH | 0.622 | 0.820 | 1.368 | 1.629 | 1.322 | 1.441 |
| 40 MPH | 0.576 | 0.638 | 1.434 | 1.615 | 1.532 | 1.808 |
| 45 MPH | 0.619 | 0.758 | 1.473 | 1.590 | 1.599 | 1.524 |
| 50 MPH | 0.652 | 1.509 | 1.556 | 2.181 | 1.729 | 2.490 |
| Overall | 0.598 | 0.884 | 1.411 | 1.676 | 1.500 | 1.753 |

### Validation Test Results—BBI Angle Computation

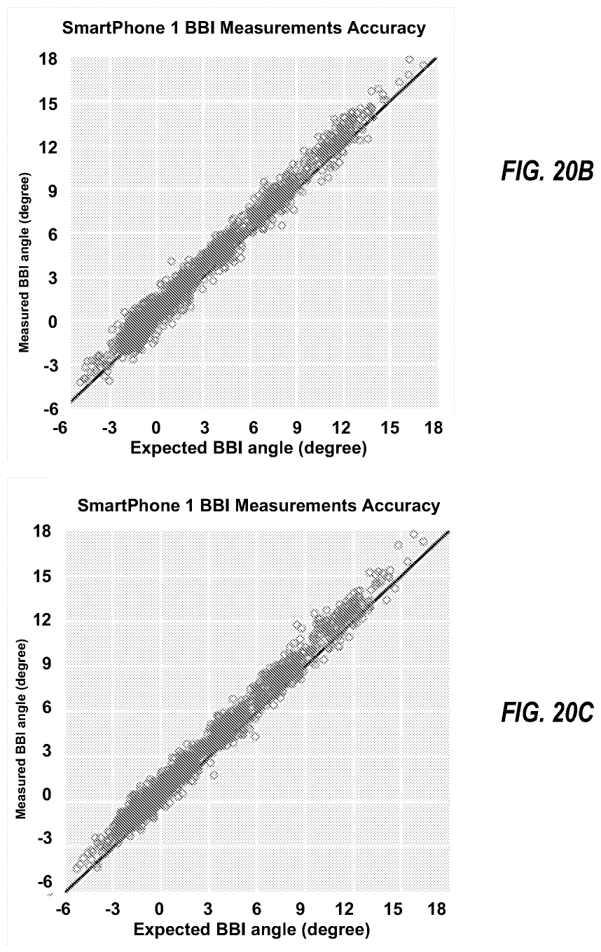

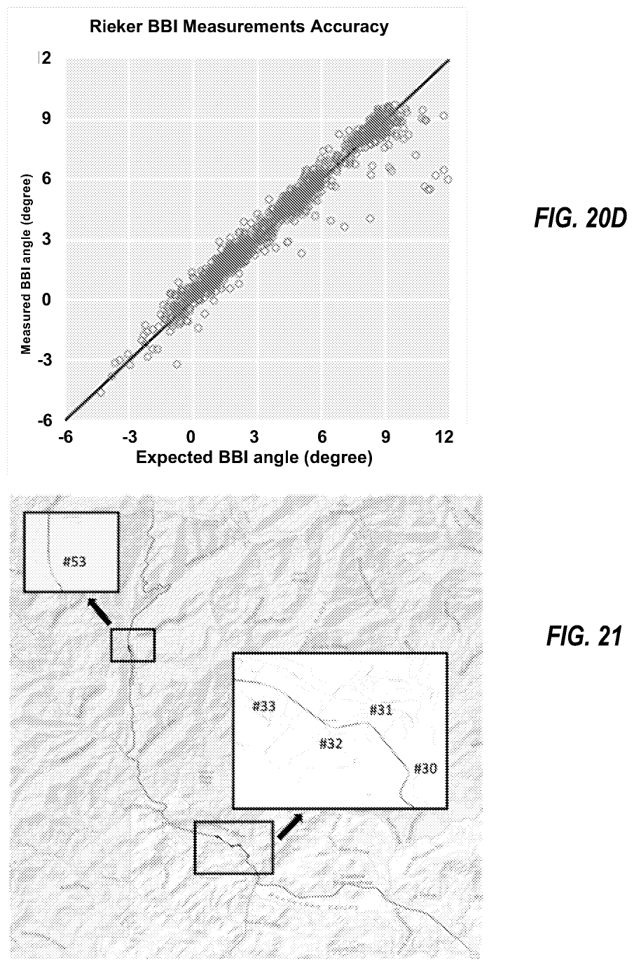

To assess the BBI angle measurement accuracy, the manually measured superelevation values were used to back-calculate the expected BBI angle based on the side-frication angle and the vehicle's body roll. Table 7 shows the RMSE of the BBI angle measured by each device. And the linear regression between measured and expected BBI angle is shown in FIGS. 20A-D.

TABLE 7
RMSE of measured BBI angles compares to expected BBI angle
computed from side-friction angles and vehicle body roll.

| | | | | ¹Rieker |
|---|---|---|---|---|
| | GoPro | Smartphone 1 | Smartphone 2 | Inclinometer |
| BBI RMSE | 0.390 | 0.901 | 0.964 | 0.519 |
| (degree) | | | | |

Because the expected BBI angle is back-calculated from side-friction angles, the accuracy of the side-friction angle, which is dependent on the measured superelevation, vehicle speed, and path radius estimation, can affect the expected BBI angle. Therefore, the RMSE values presented in the table do not represent the BBI measurement error by itself. However, since the true BBI angle at every moment of data collection can be difficult to obtain, the RMSE values presented are a good general indication of the BBI measurement accuracy.

### Validation Test Results—Advisory Speed Computation

Table 8 shows the advisory speed results using an exemplary method of the present disclosure. From the manually measured superelevation, the exact advisory speed on the test track curves should be 49.7 MPH. The validation results show that, without calibration, as the superelevation is underestimated, the determined advisory speed decreases as data collection speed increases; however, the advisory speed difference between the lowest data collection speed and the highest data collection is less than 2 MPH.

After calibration, the superelevation is no longer being underestimated at high speed. The advisory speed results are very consistent at different speeds. The variation of the advisory speed across all data collection speeds is less than 1 MPH. Compared to the advisory speed computed from manually measured superelevation, the advisory speed results from the GoPro showed less than 0.5 MPH difference (underestimation), and the smartphones showed less than 1.3 MPH difference (underestimation).

TABLE 8
Advisory speed results before and after calibration.

| | GoPro | | Smartphone 1 | | Smartphone 2 | |
|---|---|---|---|---|---|---|
| | Average | | Average | | Average | |
| Driving | Adv. | Standard | Adv. | Standard | Adv. | Standard |
| Speed | Speed | Deviation | Speed | Deviation | Speed | Deviation |

Before Calibration

| | | | | | | |
|---|---|---|---|---|---|---|
| 30 MPH | 49.618 | 0.197 | 48.545 | 0.285 | 48.791 | 0.323 |
| 35 MPH | 49.266 | 0.231 | 47.986 | 0.748 | 48.692 | 0.181 |
| 40 MPH | 49.066 | 0.333 | 47.870 | 0.070 | 47.890 | 0.237 |
| 45 MPH | 48.339 | 0.404 | 47.674 | 0.320 | 47.591 | 0.408 |
| 50 MPH | 48.095 | 0.408 | 46.892 | 0.431 | 46.690 | 0.393 |
| Overall | 48.877 | 0.670 | 47.794 | 0.643 | 47.931 | 0.830 |

After Calibration

| | | | | | | |
|---|---|---|---|---|---|---|
| 30 MPH | 49.635 | 0.177 | 48.588 | 0.278 | 48.852 | 0.300 |
| 35 MPH | 49.616 | 0.220 | 48.405 | 0.679 | 49.077 | 0.196 |
| 40 MPH | 49.782 | 0.319 | 48.692 | 0.066 | 48.749 | 0.262 |
| 45 MPH | 49.466 | 0.435 | 48.862 | 0.256 | 48.866 | 0.373 |
| 50 MPH | 49.621 | 0.373 | 48.620 | 0.396 | 48.412 | 0.380 |
| Overall | 49.624 | 0.324 | 48.633 | 0.412 | 48.791 | 0.340 |

### Sensitivity of Advisory Speed Results and Tolerance for Computation Error

Because the curves at the NCAT test track only have one curve geometry, a mathematical sensitivity study was conducted to determine the tolerance for error for curves with different geometry. Since the advisory speeds are typically rounded down to the closest 5 MPH, the error tolerances presented in Table 9 show the amount of error allowed in each factor that will not change the final computed advisory speed.

TABLE 9
Error tolerance for the computed data items

| | Most Sensitive | Error | | Least Sensitive | Error | |
|---|---|---|---|---|---|---|
| Factor | When . . . | Tolerance | | When . . . | Tolerance | |
| BBI angle | Large Radius, Low | 1 | degree | Small Radius, High | 6 | degrees |
| | Speed | | | Speed | | |
| Superelevation | Large Radius | 3% | | Small Radius | 8% | |
| Curve Radius | Low BBI, Low Speed | 150 | ft | High BBI, High Speed | 350 | ft |

As shown in Table 9, the sensitivity of each factor can depend on the curve geometry and data collection characteristics. For accurate results in all cases, it is desirable for the BBI to be precise within 1 degree, the superelevation to be precise within 3%, and the curve radius to be precise within 150 ft. From the validation results presented in this section, it can be concluded that the accuracy of the computed BBI angle, superelevation, and curve radius can be within the error tolerance.

### Validation Summary

The validation test presented herein showed that using vehicle roll rate in superelevation calculation can reduce the error caused by different data collection speeds. It also shows that the exemplary method can estimate the vehicle's roll rate to compensate in superelevation calculation. The superelevation results before calibration showed an overall RMSE of about 1.0% slope for the GoPro camera, and about 2.0-2.2% slope for the smartphones. The superelevation error before calibration increases as driving speed increases, the superelevation RMSE at 50 MPH for the GoPro camera is about 1.8% slope, and 3.2% slope for the smartphones. After calibration, the superelevation error introduced by the driving speed is almost completely eliminated, resulting in an overall RMSE of about 0.6% slope for the GoPro camera, and about 1.4-1.5% slope for the smartphones. The BBI angle validation showed the GoPro camera (RMSE=0.39 degrees) can estimate the BBI angle accurately enough to be comparable to commercial BBI devices (RMSE=0.52 degrees), while the smartphones have an RMSE of 0.9-0.96 degrees, slightly worse than commercial devices but accurate enough for advisory speed determination. Finally, the advisory speed results show that the determined advisory speeds are very close to the advisory speed computed using measured superelevation, having a difference of less than 3 MPH before calibration and about 1 MPH after calibration.

### Case Study

This section presents a preliminary case study using five runs of smartphone data collected on Georgia State Route 17. The case study demonstrates the use of an exemplary method of the present disclosure using smartphones to perform curve safety assessments. The purpose of this case study is to demonstrate the feasibility of using the exemplary method to derive the curve radius, BBI, superelevation, and advisory speed using smartphones. Furthermore, the case study provides an assessment of the confidence level of the outcomes. In addition, the smartphone and Rieker device were both mounted in the same vehicle, simultaneously to collect data for comparison. This is to compare the outcomes derived using the exemplary method of the present disclosure to those of the current, commonly used current assessment method, which uses dedicated Rieker devices.

### Feasibility Study of an Exemplary Method Using Smart Phone Data Collected on Georgia State Route 17

The purpose of this case study is to assess and demonstrate the feasibility of using an exemplary method of the present disclosure to derive the curve radius, BBI, superelevation, and advisory speed using smartphones and the smartphone data collected on Georgia State Route (SR) 17.

### Data Collection

After discussing the best locations to test the proposed method with traffic engineers in the Georgia Department of Transportation (GDOT), SR 17 was chosen as the best location on which to perform this feasibility study because of the curvy nature of SR 17 and the frequency of crashes on the road. FIG. 21 shows a map of the SR 17 test sites chosen for data collection with a close view of five curve sections that were used for the detailed data processing and analysis in this feasibility study. The selected portion of SR 17 is a two-lane, undivided rural minor arterial road with occasional painted/striped medians. This portion of SR 17 is mountainous and has many curves.

The field data collection using smartphones was conducted with five runs in each direction. Data collection was carried out with four GDOT Ford F150s and one Ford Fusion. Five runs in each direction were made in sunny weather conditions. Each vehicle was equipped with one smartphone for data collection. The phone is a regular Android smartphone and the same smartphone was used in all field data collection. The smartphone data collected includes 1) timestamp, 2) speed, 3) GPS data, and 4) IMU data.

### Data Processing

The collected smartphone data, including timestamp, speed, GPS data, and IMU data, were processed for each of the five single runs, respectively. Since the detailed description of the data processing is discussed above, it will not be duplicated in this section. The subsequent section presents the data analysis.

### Data Analysis

The data collected using smartphones were processed to find the curve radius, BBI, superelevation, and advisory speed at each point. Using the five runs of data, the inherent variability of the outcomes can be assessed using smartphone data. Table 10 presents the location and geometry of the five curves tested. Table 11 shows the range of radius, BBI, superelevation, and computed advisory speed for each curve. The BBI and superelevation values refer to those at the point of minimum computed advisory speed.

TABLE 10
Characteristics of the five curves tested on SR 17.

| Curve | | | Radius | Length |
|---|---|---|---|---|
| ID | Latitude | Longitude | (ft) | (ft) |
| 30 | 34.69346272 | −83.71341549 | 287 | 386 |
| 31 | 34.69683579 | −83.71588127 | 222 | 320 |
| 32 | 34.69679324 | −83.71802552 | 350 | 430 |
| 33 | 34.69904781 | −83.72191988 | 1135 | 733 |
| 53 | 34.75750134 | −83.75033975 | 921 | 575 |

TABLE 11
Variability of curve characteristics estimated using smartphone.

| | | | | | | |
|---|---|---|---|---|---|---|
| | | | | | Posted | Final |
| | | | | Advisory | Speed | Advisory |
| Curve | Radius | BBI | Superelevation | Speed | Limit | Speed |
| ID | (ft) | (degrees) | (%) | (MPH) | (MPH) | (MPH) |

Northbound

| | | | | | | |
|---|---|---|---|---|---|---|
| 30 | 192-239 | 0.10-5.70 | 2.72-5.49 | 32.13-33.94 | 55 | 30 |
| 31 | 181-192 | 0.16-1.68 | 4.79-7.52 | 29.44-30.94 | 55 | 30 |
| 32 | 255-280 | 2.86-12.98 | 0.05-1.55 | 33.46-33.75 | 55 | 30 |
| 33 | 844-981 | 0.23-1.45 | 3.73-5.52 | 65.22-66.64 | 55 | None |
| 53 | 563-780 | 0.23-3.97 | 0.15-4.74 | 54.40-59.95 | 55 | None |

Southbound

| | | | | | | |
|---|---|---|---|---|---|---|
| 30 | 192-229 | 3.51-7.14 | 0.57-2.47 | 30.66-31.96 | 55 | 30 |
| 31 | 154-199 | 1.81-5.84 | 1.92-6.78 | 27.77-30.54 | 55 | 30 |
| 32 | 280-317 | 0.71-4.56 | 0.01-11.10 | 33.42-35.03 | 55 | 35 |
| 33 | 812-975 | 0.32-1.61 | 2.57-5.72 | 62.16-67.76 | 55 | None |
| 53 | 650-826 | 2.76-6.88 | 0.17-0.80 | 54.42-55.22 | 55 | None |

Using five sample curves on SR 17, it was found that the average variability of measurements between runs of the data collection is approximately 49 feet for the radius, 8 degrees for the BBI, 5% for the superelevation, and 2 MPH for the computed advisory speed. Table 11 and Table 12 list the range of the estimated radius, measured BBI, estimated superelevation, and computed advisory speed values of the five runs of data for the five selected curves in the Northbound and Southbound directions, respectively. The results show that there is a high level of consistency in the advisory speed computation among the five runs of smart phone data, which means there is a high confidence in the outcomes.

For the advisory speed computation, a standard practice is to add 1 MPH and then round down the raw computed result to the nearest multiple of 5 MPH for advisory speed plaque design. If all runs of the data collection yield the same rounded computed advisory speed, it can indicate a very high confidence in that result. For the five sample curves studied on SR 17, each curve had ten total passes of smart phone data collection, five in each direction. The number of passes from each curve yielding the same advisory speed are shown in Table 12.

TABLE 12
Consistency of computed advisory speed from multiple runs.

| | | Design Advisory | Runs in |
|---|---|---|---|
| Curve ID | Direction | Speed | Agreement |
| 30 | Northbound | 30 MPH | 5/5 |
| | Southbound | 30 MPH | 5/5 |
| 31 | Northbound | 30 MPH | 5/5 |
| | Southbound | 30 MPH | 4/5 |
| 32 | Northbound | 30 MPH | 5/5 |
| | Southbound | 30 MPH | 4/5 |
| 33 | Northbound | 65 MPH | 5/5 |
| | Southbound | 65 MPH | 4/5 |
| 53 | Northbound | 55 MPH | 4/5 |
| | Southbound | 55 MPH | 5/5 |

This demonstrates a high level of repeatability in the outcomes of the exemplary method using smart phones. It should be noted that due to the nature of the advisory speed rounding, two computations that are very close could give different advisory speeds (e.g., 29 would be rounded to 30 MPH while 28 would be rounded to 25 MPH). So, some variation in the final computed advisory speed is acceptable. If a curve has more than 5 MPH of variation between the computed advisory speeds from different runs, the result is significantly different enough that the data should be re-collected. In choosing the appropriate advisory speed for a curve, the highest computed advisory speed from the multiple runs can be selected because the highest computed advisory speed can be the closest to the true roadway conditions. The computation can be skewed unnaturally low through erratic driver behavior (changing speeds, jerking the wheel, failing to follow the road trajectory, etc.). On the contrary, there may be no way to unnaturally increase the computed advisory speed through human error, so the highest result can most closely estimate the true value. The analysis of five curves on SR 17 demonstrates that the exemplary method of the present disclosure tested using smartphones is feasible to compute the curve radius, BBI, superelevation, and advisory speed.

### Comparison of Outcomes Using an Exemplary Method Using Smart Phones and a Method Using Rieker Devices

As most transportation agencies are currently using a method that uses dedicated Rieker devices, a comparison was made from the outcomes of an exemplary method of the present disclosure (that uses smartphones) and the current commonly used method (that uses dedicated Rieker devices). One vehicle was equipped with both a smartphone and a RIEKER device for comparing the performance between the exemplary method and the method with RIEKER devices. Table 13 below compare the computed advisory speed output from each method. As shown, for these five sample curves, the proposed method and the Rieker method produce results within 6 MPH of one another. Thus, these two methods are comparable.

TABLE 13
Computed advisory speed comparison.

| | | | |
|---|---|---|---|
| | | | Posted Speed |
| | | Advisory Speed | Limit |
| Curve ID | Source | (MPH) | (MPH) |

Northbound

| | | | |
|---|---|---|---|
| 30 | Smart Phone | 32.7 | 55 |
| | Rieker | 30.4 | 55 |
| 31 | Smart Phone | 30.5 | 55 |
| | Rieker | 25.9 | 55 |
| 32 | Smart Phone | 33.5 | 55 |
| | Rieker | 34.5 | 55 |
| 33 | Smart Phone | 65.7 | 55 |
| | Rieker | 60.1 | 55 |
| 53 | Smart Phone | 55.3 | 55 |
| | Rieker | 56.9 | 55 |

Southbound

| | | | |
|---|---|---|---|
| 30 | Smart Phone | 32.0 | 55 |
| | Rieker | 30.8 | 55 |
| 31 | Smart Phone | 30.5 | 55 |
| | Rieker | 29.2 | 55 |
| 32 | Smart Phone | 33.9 | 55 |
| | Rieker | 34.0 | 55 |
| 33 | Smart Phone | 67.8 | 55 |
| | Rieker | 64.1 | 55 |
| 53 | Smart Phone | 54.4 | 55 |
| | Rieker | 50.2 | 55 |

The smartphone data and Rieker data can also be compared in terms of repeatability. The repeatability of the computed advisory speed can be important because it can determine the overall confidence in the outcome. For the aforementioned five sample curves, the standard deviation of the computed advisory speed between the multiple runs of data collection was computed. It was found that the standard deviation of the computed advisory speed derived from the smartphone data is 0.89 MPH, and the standard deviation of the computed advisory speed derived from the Rieker data is 1.59 MPH. Thus, the advisory speed computation using an exemplary method of the present disclosure is more consistent.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A method comprising:
determining, based at least in part from data collected by at least one user device located within an automobile traversing along a road comprising one or more curved portions, one or more kinematic properties of the automobile;
determining, based at least in part on the data collected, a curve geometry of an investigated curved portion selected from the one or more curved portions;
determining, based at least in part on the data collected, an advisory driving speed for the investigated curved portion; and
determining, based at least in part on the data collected, desired curve signage for display relative to the investigated curved portions.

2. The method of claim 1, wherein the data collected is selected from a group consisting of data indicative of a speed of the user device, data indicative of a global positioning system (GPS) location of the user device, data comprising inertial measurement unit (IMU) data of the user device, video data of the investigated curved portion, and a combination thereof.

3-9. (canceled)

10. The method of claim 1, wherein determining the curve geometry comprises:
determining a point of curvature of the investigated curved portion;
determining a point of tangent of the investigated curved portion;
determining a curve radius for of investigated curved portion;
determining a deviation angle of the investigated curved portion; and
determining a superelevation of the investigated curved portion.

11.-12. (canceled)

13. The method of claim 10, wherein the curve radius is based, at least in part, on GPS data and/or roadway centerline data in the data collected.

14. (canceled)

15. The method of claim 10, wherein the deviation angle is based, at least in part, on GPS data and/or roadway centerline data in the data collected.

16. (canceled)

17. The method of claim 10, wherein the superelevation is based, at least in part, on:
speed data in the data collected; and
a path radius and ball-bank indicator (BBI) determined, based at least in part, on the data collected.

18. (canceled)

19. The method of claim 10, wherein determining the advisory driving speed is based, at least in part, on the curve radius and the superelevation of the investigated curved portion.

20. The method of claim 19, wherein the curve radius and the superelevation of the investigated curved portion are determined based, at least in part, on the data collected.

21. The method of claim 10, wherein the advisory driving speed is determined by:
$${V}_{adv} = \sqrt{15 * ( \frac{e}{100} + {f}_{max} ) * {R}_{c}}$$
wherein:
fₘₐₓ is a maximum allowed side friction factor;
R_{c} is the curve radius expressed in feet; and
V_{adv} is the advisory driving speed expressed in miles per hour.

22. (canceled)

23. The method of claim 1, wherein two of the one or more kinematic properties comprise:
a path radius taken by the automobile when traversing along the investigated curved portion; and
a BBI of the automobile when traversing along the investigated curved portion.

24. The method of claim 23, wherein the path radius is based, at least in part, on speed data and IMU data in the data collected.

25.-26. (canceled)

27. The method of claim 23, wherein the BBI is determined, at least in part, by:
$$α ( {t}_{i} ) = ( atan ( \frac{{( 1.47 * V ( {t}_{i} ) )}^{2}}{{gR}_{p} ( {t}_{i} )} ) - atan ( \frac{e ( {t}_{i} )}{100} ) ) * ( 1 + k ) ;$$
and
wherein:
α(tᵢ) is the BBI at time tᵢ;
V(tᵢ) is a speed of the automobile at time tᵢ;
g is the gravitational force of Earth;
Rₚ(tᵢ) is the path radius of the automobile at time tᵢ; and
k is a roll rate of the automobile expressed in (rad/rad).

28. The method of claim 1 further comprising displaying a list of the desired curve signage;
wherein displaying comprises at least one of:
displaying a list of coordinates and a desired sign for each of the coordinates, each of the coordinates corresponding to a geographic location; or
displaying a map, the map comprising the investigated curved portion and the desired curve signage.

29.-31. (canceled)

32. The method of claim 1 further comprising:
determining, based at least in part on the data collected, existing signage currently displayed relative to the investigated curved portions;
comparing the existing signage to the desired curve signage; and
generating, based at least in part on the comparing, a list of signs to be added and/or to be removed from the existing signage so future signage displayed relative to the investigated curved portion matches the desired curve signage.

33.-38. (canceled)

39. A method comprising:
determining, based at least in part from data collected by a set of user devices, one or more of the user devices from the set of user devices located within different automobiles, each of the automobiles having driven along one or more roads comprising one or more curved portions, kinematic properties of the automobiles;
determining, based at least in part on the data collected, a curve geometry for the curved portions;
determining, based at least in part on the data collected, advisory driving speeds for the curved portions;
determining, based at least in part on the data collected, desired curve signage for display at the curved portions;
displaying a list of the desired curve signage; and
generating an output indicative of the advisory driving speeds.

40. The method of claim 39, determining the curve geometries comprises:
determining a point of curvature of the each of the curved portions;
determining a point of tangent of the each of the curved portions;
determining a curve radius for of the each of the curved portions;
determining a deviation angle of the each of the curved portions; and
determining a superelevation of each of the curved portions;
wherein the superelevations are based, at least in part, on:
speed data in the data collected; and
a path radius and BBI determined, based at least in part, on the data collected.

41. The method of claim 40, wherein the kinematic properties comprise:
a path radius taken by the automobiles when traversing along the curved portions; and
a BBI of the automobiles when traversing along the curved portions.

42. The method of claim 41, wherein the advisory driving speed is determined by:
$${V}_{adν} = \sqrt{15 * ( \frac{e}{100} + {f}_{max} ) * {R}_{c}}$$
wherein:
fₘₐₓ is a maximum allowed side friction factor;
R_{c} is the curve radius expressed in feet; and
V_{adv} is the advisory driving speed expressed in miles per hour;
wherein the BBI is determined, at least in part, by:
$$α ( {t}_{i} ) = ( atan ( \frac{{( 1.47 * V ( {t}_{i} ) )}^{2}}{{gR}_{p} ( {t}_{i} )} ) - atan ( \frac{e ( {t}_{i} )}{100} ) ) * ( 1 + k ) ;$$
and
wherein:
α(tᵢ) is the BBI at time tᵢ;
V(tᵢ) is a speed of each automobile at time tᵢ;
g is the gravitational force of Earth;
Rₚ(tᵢ) is the path radius of each automobile at time tᵢ; and
k is a roll rate of each automobile expressed in (rad/rad).

43. A system for improving curve signage comprising:
one or more processors, individually and/or collectively, configured to execute code causing the system to:
perform the method of claim 1.

44.-81. (canceled)

82. A system comprising:
one or more processors, individually and/or collectively, configured to execute code causing the system to:
perform the method of claim 39.

83.-84. (canceled)
